(19) United States
(12) Patent Application Publication
(10) Pub. No.: US 2023/0155104 A1
(43) Pub. Date: May 18, 2023

(54) CONCURRENT ELECTROPHORETIC DEPOSITION OF MEMBRANE-ELECTRODE-ASSEMBLY

(71) Applicant: RAMOT AT TEL-AVIV UNIVERSITY LTD., Tel Aviv (IL)

(72) Inventors: Diana GOLODNITSKY, Tel Aviv (IL); Elazar COHEN, Tel Aviv (IL)

(21) Appl. No.: 17/995,610

(22) PCT Filed: Apr. 7, 2021
(86) PCT No.: PCT/IL2021/050391

§ 371 Date: Oct. 6, 2022

Related U.S. Application Data
(60) Provisional application No. 63/006,088, filed on Apr. 7, 2020.

(51) Int. Cl. H01M 4/04; H01M 10/0565; H01M 4/62; H01M 4/525; H01M 10/0525; H01M 50/109; C25D 13/12

(52) U.S. Cl. CPC H01M 4/0457; H01M 10/0565; H01M 4/625; H01M 4/525; H01M 10/0525; H01M 50/109; C25D 13/12; H01M 2300/0082

(57) ABSTRACT

The present invention provides a method for concurrent electrophoretic deposition (EPD) of a membrane-electrode assembly (MEA) comprising a first MEA electrode and a second MEA electrode. The method comprises electrophoretically depositing the first MEA electrode from a suspension comprising a first precursor on a first surface of an ion permeable membrane and electrophoretically depositing the second MEA electrode from a second suspension comprising a second precursor on a second surface of the ion permeable membrane, wherein the first precursor is physically separated from and ionically connected to the second precursor by the membrane.

### FIELD OF THE INVENTION

The present invention is directed to electrophoretic deposition (EPD) of membrane electrode assemblies (MEA), which can be used in various types of energy storage devices.

### BACKGROUND OF THE INVENTION

As an era of smart and ubiquitous energy is rapidly approaching, flexible power sources, which feature aesthetic versatility and facile integration with electronic devices of various sizes and shapes, attract considerable interest. The growing investments in the development of wearable technologies and devices are significantly boosting the revenue generation opportunities for flexible battery manufacturers. The focus on shifting towards miniaturized products coupled with the booming demand for consumer electronics are some of the key driving factors behind the flexible-battery market. In the development of innovative power sources, freeing from design limitation along with the synthesis of reliable electrochemical materials with well-tuned features, is considered to be the most important technical prerequisite,

Research on flexible lithium-ion batteries has mainly been focused on the development of nano-engineered electroactive materials, shape-conformable electrolytes, and soft current collectors. In fact, the choice of the positive or the negative electrode material to fabricate a flexible lithium-ion battery is not as problematic as the choice of the processing procedure needed to transfer the powdered material into a thin or thick mechanically-strong film on the preferred current collector. In the recent studies, the flexible electrodes are usually prepared on current collectors by processes like vacuum-assisted filtration, chemical vapor deposition (CVD), sputtering, blade casting, or even more complex nanofabrication. Most of these processes are feasible in lab-scale studies, but they are insufficient for scaling up to mass production. Physical vapor deposition, DC or RF magnetron sputtering and pulsed laser-deposition techniques, which are typically used for depositing electrode materials for flexible batteries, are quite expensive. In addition, their top-down deposition nature does not meet the need to conformally deposit highly adhesive electrode materials on membrane. CVD techniques are expensive and heating of the substrate during deposition or annealing of the obtained coating is usually required to ensure crystallinity for optimum battery performance. Blade casting is widely used for the fabrication of single electrode (cathode or anode) on metallic current collectors, but it is inapplicable to coating of porous membranes, since the slurry is applied to the current collector under pressure. The slurry can penetrate the pores of membrane and cause short circuits.

For some time now, solution-based processing of electrode materials (electrolytic deposition, electrophoretic deposition, sol-gel deposition, serigraphy, ink-jet printing, and chemical-bath deposition) has been shown to be handy and cost-effective in preparing thin-film electrodes for improved electrochemical-energy storage. Among the solution-based deposition techniques, electrophoretic deposition (EPD) is currently gaining attention for preparing battery electrodes, especially due to the fact that the crystallinity of the starting powder is always retained in the deposited film (N. A. Kyeremateng, T. M. Dinh, D. Pech, Electrophoretic deposition of Li₄Ti₅O₁₂ nanoparticles with a novel additive for Li-ion microbatteries, RSC Adv. 5 (2015) 61502-61507; A. Caballero, L. Hernán, M. Melero, J. Morales, R. Moreno, B. Ferrari, LiNi_{0.5}Mn_{1.5}O₄ thick-film electrodes prepared by electrophoretic deposition for use in high voltage lithium-ion batteries, J. Power Sources. 158 (2006) 583-590; L. Besra, M. Liu, A review on fundamentals and applications of electrophoretic deposition (EPD), Prog. Mater. Science. (2007) 1-61). In addition, EPD has gained significant interest because of the high versatility of its use with different materials, including nanoparticles. EPD is cost-effective, as it requires only simple equipment and provides good conformal deposits on complicated geometrical surfaces. The mass loading of electrophoretically deposited materials and film thickness can be readily controlled by varying the applied voltage, colloidal-electrolyte composition and deposition time. The effects of polymers and surface-active additives in the electrolytic bath, voltage and deposition protocol were studied with the aim of obtaining highly adhesive, compact, pristine LiFePO₄ (LFP) and polymer-LiFePO₄ composite film cathodes to be utilized in planar and three-dimensional microbatteries (H. Mazor, D. Golodnitsky, L. Burstein, A. Gladkich, E. Peled, Electrophoretic deposition of lithium iron phosphate cathode for thin-film 3D-microbatteries, J. Power Sources. 198 (2012) 264-272). Several groups reported on preparation of lithium manganese phosphate (LiMnPO₄, abbreviated as “LMP”), lithium cobalt oxide (LiCoO₂, abbreviated as “LCO”), lithium manganese oxide (LiMn₂O₄, abbreviated as “LMO”) cathodes; and graphite, lithium titanate (Li₄Ti₅O₁₂, abbreviated as “LTO”) and silicon anodes for lithium-ion batteries by electrophoretic deposition (K. Kanamura, A. Goto, J. Hamagami, T. Umegaki, Electrophoretic Fabrication of Positive Electrodes for Rechargeable Lithium Batteries, Electrochem. Solid-State Lett. 3(6) (2000) 259-262; Cornel C. Lalau and Chee T. John Low, Electrophoretic Deposition for Lithium-Ion Battery Electrode Manufacture. Batteries & Supercaps, (2019) 551-559; S. P. Ravi, P. Praveen, K. V. Sreelakshmi, A. Balakrishnan, K. R. Subramanian, V. Shantikumar, Y. S. Lee, N. Sivakumar, Electrochemical Performance of Electrophoretically Deposited Nanostructured LiMnPO₄-Sucrose Derived Carbon Composite Electrodes for Lithium Ion Batteries. J. Nanosci. Nanotechnol. 15 (2015) 747-751; M. Yao, Z. Zeng, H. Zhang, J. Yan, X. Liu, Electrophoretic deposition of carbon nanofibers/silicon film with honeycomb structure as integrated anode electrode for lithium-ion batteries, Electrochim. Acta (2018) 281, 312-322). Some reports have introduced modifications to manipulate packing density by EPD and thus improve electrochemical properties (N. A. Kyeremateng, T. M. Dinh, D. Pech, Electrophoretic deposition of Li₄Ti₅O₁₂ nanoparticles with a novel additive for Li-ion microbatteries, RSC Adv. 5 (2015) 61502-61507).

US 2018/0205113 is directed to an electrical energy storage device including a substrate, an anode layer, a cathode layer, and a separator layer between the anode layer and the cathode layer. The substrate has multiple sets of intersecting cavities passing through the substrate in different directions. The anode layer, cathode layer, and separator layer are formed over a surface of the substrate within the cavities. The anode, cathode and separator can be formed using EPD.

U.S. Pat. No. 9,249,522 to some of the inventors of the present invention is directed to methods for forming three-layer thin-film battery (TFB) structures by sequential electrophoretic deposition on a single conductive substrate. The TFBs may be two-dimensional or three-dimensional. The sequential EPD includes EPD of a first battery electrode followed by EPD of a porous separator on the first electrode and by EPD of a second battery electrode on the porous separator. Preparation of three-layer battery structure made exclusively by the electrophoretic-deposition method is further described in E. Cohen, S. Menkin, M. Lifshits, Y. Kamir, A. Gladkich, G. Kosa, D. Golodnitsky, Novel rechargeable 3D-Microbatteries on 3D-printed-polymer substrates: Feasibility study, Electrochim. Acta. 265 (2018) 690-701. Tri-layered structures of LiFePO₄ cathode, LiAlO₂-PEO or Li₍₁₋ₓ₎AlyGe_{(2-y)}(PO₄)₃-PEI (LAGP) membrane, and LiTiO₂-based anode, were formed by EPD on graphene-filled conducting substrates without additional metallic current collector.

To the best of the inventors' knowledge, very few studies address the electrophoretic deposition of ceramic materials on polymer membranes. The first report is that of Sarkar and Nicholson in 1996, who used this approach to cathodically deposit yttria-stabilized zirconia (YSZ)/Al₂O₃ micro-laminates in ethanol suspension (P. Sarkar, P. S. Nicholson, Electrophoretic deposition (EPD): Mechanisms, kinetics, and application to ceramics, J. Am. Ceram. Soc. 79 (1996) 1987-2002). They used a dialysis membrane in order to separate the anode and the cathode compartments in a suspension and reported on the formation of layer-by-layer coating on the membrane. Ordung et al. presented deposition of homogeneous silicon-powder-based film on fibre fabrics, with a high packing density of more than 60 vol % and good mechanical properties (M. Ordung, J. Lehmann, G. Ziegler, Fabrication of fibre reinforced green bodies by electrophoretic deposition of silicon powder from aqueous suspensions, J. Mater. Sci. 39 (2004) 889-894).

The feasibility of preparation by EPD of a membrane electrode assembly (MEA) for a polymer-electrolyte fuel cell was demonstrated in K. Kanamura, J. I. Hamagami, Innovation of novel functional material processing technique by using electrophoretic deposition process, Solid State Ionics. 172 (2004) 303-308. The deposition of carbon with a platinum catalyst on a Nafion® polymer substrate was confirmed by SEM observation and XPS analysis. Said study further relates to LiCoO₂ composite electrodes prepared by the EPD process, further comprising Ketjen black, and polytetrafluoroethylene. It was shown that LiCoO₂, Ketjen black, and polytetrafluoroethylene interact with each other in the suspension to form precursor particles, which is a composite particle containing three kinds of materials.

The possibility of simultaneous electrophoretic deposition of oppositely charged MgO and silicon particles was tested in F. Hossein-Babaei, B. Raissidehkordi, An Investigation of the Si-Acetone-MgO EPD Cell, in: A. R. Boccaccini, O. Vanderbiest, P. S. Nicolson, J. Talbot (Eds.), Electrophor. Depos. Fundam. Appl. Proc. Int. Symp., The Electrochemical Society, 2002: pp. 47-54. MgO particles gain positive surface charge in acetone suspension, and are deposited on metal cathodes, while silicon particles have negative zeta potential and their deposition is anodic. Upon mixing of the two suspensions, the coulombic forces bring the particles together to form clusters. It was found that, depending on the relative contents of the powders, the deposition of clusters, comprising both positively and negatively charged particles, occurs either on the cathode or the anode. The particles could not be separated and could not be deposited as a single-compound film on oppositely charged electrodes even under the strong applied electric field of 200V/cm.

Simultaneous preparation of positive and negative thin-film battery electrodes as a single-step process is a very promising, but challenging approach. There exists, therefore, an unmet need for a fast, inexpensive, straightforward and scalable method for the concurrent manufacturing of the two electrodes of an electrochemical energy device, preferably, wherein said method does not require application of additional layers or pretreatment steps.

### SUMMARY OF THE INVENTION

The present invention provides a unique fabrication method of a three-layer membrane-assembly (MEA) by concurrent electrophoretic deposition of two electrodes directly on each side of an electrically insulating and ion-permeable membrane. The electrode components and the membrane can be chosen in accordance with the intended type of the electrochemical device. Advantageously, the MEAS manufactured by the disclosed method can be used in various energy devices, including, inter alia, batteries, fuel cells, flow cells, and supercapacitors. Various combinations of electrode pairs are also achievable by fine-tuning the EPD precursor solutions, while the electrodes can be deposited anodically or cathodically, by selecting suitable charging agents. The EPD process described herein is particularly suitable for manufacturing electrodes for thin-film flexible electrochemical devices, as the electrodes can be deposited in a thin layer on two sides of a flexible membrane, forming a compact membrane electrode assembly. The electrophoretic deposition process parameters can be easily altered to control the thickness and capacity of the electrodes.

The method of the present invention comprises electrophoretically depositing a first electrode from a first precursor on a first membrane surface and electrophoretically depositing a second electrode from a second precursor on a second membrane surface. The present invention is based in part on the unexpected finding that concurrent electrophoretic deposition of two opposite electrodes of an electrochemical device can be performed on two sides of an electrically insulating and ionically conductive membrane. In order to allow simultaneous and selective deposition of two different electrode materials in a mutual EPD bath and/or on different faces of a single substrate, the EPD precursors comprising the electrode materials should be oppositely charged. As mentioned hereinabove, simultaneous deposition of oppositely charged particles was shown to be unsuccessful. In accordance with the principles of the present invention, the first precursor should be physically separated from the second precursor. Without wishing to being bound by theory or mechanism of action, it is contemplated that such physical separation allows to avoid the potential formation of clusters of the two oppositely charged electrode precursors in the solution arising from the coulombic forces' attraction. However, in order to enable simultaneous deposition of the electrodes on both sides of the electrochemical device membrane, the first precursor and the second precursor should be ionically connected during the EPD process.

The inventors have shown that the EPD process fulfilling the above conditions provided a fully operational MEA comprising LFP and LTO electrodes deposited on opposite sides of a customary Li-ion battery membrane (Celgard 2325), which is electrically insulating, porous, and ion-permeable. The precursors were kept apart by disposing them in two separate compartments of a designated EPD cell, each including an electrode, said electrodes being connected through an outer circuit to establish electric field across the EPD cell. The compartments were connected through the nanoporous Li-ion membrane serving as the physical barrier to the two-way penetration of precursor particles, while still maintaining a strong electric field between the two electrodes of the EPD cell and throughout its entire volume. The Li-ion membrane therefore served not only as a substrate for forming the LFP and LTO electrodes, but also as a separator during the EPD process, therefore allowing simultaneous deposition of the LFP and LTO electrode materials on the opposed surfaces of the membrane. The LFP/Celgard/LTO MEA cell has been reversibly cycled for more than 150 times at different C-rates with 125-140 mAh/g capacity, which is close to that of the theoretical LFP value.

It has further been demonstrated by the inventors, that the mean pore size of the membrane and the mean particle size of the precursor particles should be carefully chosen in order to maintain physical separation between the two different precursors throughout the EPD process. In particular, it has been found that preferably, the mean pore size of the membrane should be smaller than the mean particle size of the precursor particles.

According to a first aspect, the present invention provides a method for concurrent electrophoretic deposition (EPD) of a membrane-electrode assembly (MEA) comprising a first MEA electrode and a second MEA electrode, comprising: (i) providing an electrically insulating ion-permeable membrane having two opposed surfaces comprising a first surface and a second surface; and (ii) electrophoretically depositing the first MEA electrode from a suspension comprising a first precursor on the first surface of the membrane and electrophoretically depositing the second MEA electrode from a second suspension comprising a second precursor on the second surface of the membrane, wherein the first precursor is physically separated from and ionically connected to the second precursor by said membrane.

According to some currently preferred embodiments, the first MEA electrode and the second MEA electrode are deposited concurrently.

According to some embodiments, the membrane is a porous separator selected from the group consisting of a polymer separator, ceramic separator, zeolite separator, glass separator, and combinations thereof. Each possibility represents a separate embodiment of the invention. The porous separator can have a mean pore size ranging from about 0.01 to about 10 μm.

In certain embodiments, the porous separator comprises a polymer separator. In further embodiments, the polymer separator comprises a polymer selected from the group consisting of polyethylene (PE), polypropylene (PP), poly (tetrafluoroethylene) (PTFE), polyvinyl chloride (PVC), polyvinylidene difluoride (PVDF), polymethyl methacrylate, and combinations thereof. Each possibility represents a separate embodiment of the invention.

According to some embodiments, the membrane is an ion exchange membrane. The ion exchange membrane can be selected from the group consisting of a non-alkaline anion exchange membrane, alkaline anion exchange membrane (AAEM), hydroxide-exchange membrane (HEM), anion-exchange ionomer membrane (AEI), non-acidic cation exchange membrane, proton-exchange membrane (PEM), cation-exchange ionomer membrane, and combinations thereof. Each possibility represents a separate embodiment of the invention.

According to some embodiments, the first precursor, the second precursor or both are in a form of colloidal particles suspended in a liquid electrolyte, wherein the colloidal particles of the first precursor and of the second precursor have opposite polarities.

In some embodiments, the colloidal particles have a mean particle size, which is at least about 5% larger than the mean pore size of the membrane. In further embodiments, the colloidal particles have a mean particle size, which is at least about 60% larger than the mean pore size of the membrane.

According to some embodiments, the liquid electrolyte comprises a solvent selected from the group consisting of acetone, acetyl acetone, water, benzene, toluene, methanol, ethanol, isopropyl alcohol, 1,4-butanediol, dichloromethane, glacial acetic acid, and combinations thereof. The liquid electrolyte can further comprise at least one of sulfuric acid, hydrochloric acid, perchloric acid, trifluoromethanesulfonic acid, nitric acid, benzoic acid, iodine, sodium hydroxide, potassium hydroxide, ammonium hydroxide, and tetramethylammonium hydroxide (TMAH). Each possibility represents a separate embodiment of the invention.

According to some embodiments, the first precursor comprises a first electrode active material and the second precursor comprises a second electrode active material.

According to some embodiments, the first electrode active material comprises a lithiated active material, selected from the group consisting of LiFePO₄, LiMnPO₄, LiCoPO₄, LiCoO₂, LiNiO₂, Li(Al,Ni,Mn)O₂, LiMnO₂, LiMn₂O₄, Li₂MnO₃, LiNiMnCoO, and combinations thereof. In further embodiments, the second electrode active material is a Li-battery anode active material, selected from the group consisting of lithium titanate (Li₄Ti₅O₁₂), graphitic carbon, disordered carbon, tin oxide, indium tin oxide, vanadium oxide, manganese oxide, chromium oxide, iron oxide, nickel oxide, cobalt oxide, lithium-silicon, tin-cobalt, silicon, aluminum, zinc, tin, silver, antimony, bismuth, and combinations thereof. Each possibility represents a separate embodiment of the invention.

According to some embodiments, the first electrode active material, the second active electrode material or both comprise a fuel cell or flow cell electrode active material, selected from the group consisting of carbon, metal, metal carbide, metal nitride, metal oxide, transition metal chalcogenide, transition metal macrocyclic compound, conducting polymer, and combinations thereof. The metal can be selected from the group consisting of Pt, Pd, Ru, Au, Ag, Ir, Rh, Re, Cu, Ce, Cd, Zn, Fe, Mo, Ni, Co, Cr, Al, and alloys, and combinations thereof. Each possibility represents a separate embodiment of the invention.

According to some embodiments, the first electrode active material, the second active electrode material or both comprise a supercapacitor electrode active material selected from the group consisting of carbon, metal, metal phosphate, metal nitride, metal oxide, transition metal chalcogenide, conducting polymer, and combinations thereof.

The carbon can be provided in a form of graphitic carbon, activated carbon, carbon black, carbon beads, carbon fibers, carbon microfibers, carbon cloth, carbon paper, fullerenic carbons, carbon nanotubes (CNTs), graphene sheets or aggregates of graphene sheets, and materials comprising fullerenic fragments.

The metal oxide can be selected from the group consisting of MnₙOₓ, TiOₓ, NiOₓ, CoOₓ, SnOₓ, and combinations thereof, wherein x ranges from 1.5 to 3 and/or wherein the transition metal chalcogenide is selected from the group consisting of FeS_{y}, MoS_{y}, NiS_{y}, CoS_{y}, MnS_{y}, TiS_{y}, SnS_{y} and combinations thereof, wherein y ranges from 1.8 to 2.2 and n ranges from 1 to 2. Each possibility represents a separate embodiment of the invention.

According to some embodiments, the first precursor, the second precursor or both further comprise a charging agent. In further embodiments, the charging agent is selected from the group consisting of PAA, PEI, Nafion, polydiallyldimethylammonium (PDDA), and polystyrene sulfonic acid (PSS). Each possibility represents a separate embodiment of the invention.

The first precursor, the second precursor or both can further comprise a binder selected from the group consisting of PAA, PVDF, polyacrylonitrile (PAN), poly-methyl methacrylate (PMMA), carboxymethyl cellulose (CMC), and combinations thereof. Each possibility represents a separate embodiment of the invention.

According to some embodiments, the first precursor, the second precursor or both further comprise a conducting agent selected from the group consisting of carbon black, graphite, meso-porous micro-beads (MCMB), single- and multiwall carbon nanotubes, metal nanoparticles, and combinations thereof. Each possibility represents a separate embodiment of the invention.

In some exemplary embodiments, the first suspension comprises the first precursor comprising LiFePO₄, branched PEI, PAA, and carbon black. In further embodiments, the first precursor comprises: about 70-95% (w/w) LiFePO₄; about 0.01-1% (w/w) branched PEI; about 0.5-5% (w/w) PAA; and about 5-20% carbon black.

In further exemplary embodiments, the second suspension comprises the second precursor comprising Li₄Ti₅O₁₂, PAA, and carbon black. In still further embodiments, the second precursor comprises: about 70-95% (w/w) Li₄Ti₅O₁₂; about 1-7% (w/w) PAA; and about 5-20% carbon black.

In further exemplary embodiments, the first suspension and the second suspension comprise acetone and acetylacetone as the liquid electrolyte. In certain embodiments, the first suspension and the second suspension further comprise ethanol.

The first precursor can be formed by suspending the first electrode active material and the charging agent, and optionally, the conducting agent in the liquid electrolyte. Similarly, the second precursor can be formed by suspending the second electrode active material and the charging agent, and optionally, the conducting agent in the liquid electrolyte.

According to some embodiments, step (ii) is performed in an electrochemical cell comprising a first EPD electrode and a second EPD electrode, which are in ionic contact with the membrane; and a first compartment and a second compartment, which are separated by the membrane, wherein the first precursor is disposed in the first compartment and the second precursor is disposed in the second compartment.

In some embodiments, the first compartment is disposed within the second compartment. In some embodiments, the first compartment and the second compartment are linearly aligned.

According to some embodiments, the first EPD electrode is disposed within the first compartment and the second electrode is disposed within the second compartment. In further embodiments, the first EPD electrode, the second EPD electrode or both are disposed within less than about 30 cm from the membrane.

The EPD process in step (ii) can be performed at a constant voltage ranging from about 20 to about 600 V. In some embodiments, the EPD process in step (ii) is performed for from about 5 seconds to about 30 minutes.

According to another aspect, there is provided a membrane-electrode assembly (MEA) prepared by the method for concurrent electrophoretic deposition (EPD) as described hereinabove. According to some embodiments, the first MEA electrode comprises the first electrode active material and the second MEA electrode comprises the second electrode active material. The first MEA electrode, the second MEA electrode or both can further comprise at least one of the charging agent, the conducting agent, and the binder. According to some currently preferred embodiments, the first MEA electrode is essentially free of the second electrode active material and/or the second MEA electrode is essentially free of the first electrode active material.

According to yet another aspect, there is provided an energy storage device comprising the MEA according to the various embodiments hereinabove. The energy storage device can be selected from the group consisting of a Li-ion battery, fuel cell, flow cell, supercapacitor, and photoelectrochemical cell. Each possibility represents a separate embodiment of the invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A: Schematic representation of the electrochemical cell comprising two compartments and separated by the MEA membrane, according to some embodiments of the present invention.

FIG. 1B: Exploded view of the electrochemical cell of FIG. 1A, according to some embodiments of the present invention.

FIG. 2: Schematic representation of the electrochemical cell comprising two compartments and separated by the MEA membrane, wherein the first compartment is disposed within the second compartment, according to some embodiments of the present invention.

FIG. 3: Schematic representation of the electrochemical cell comprising two compartments and separated by the MEA membrane, wherein the first compartment is disposed within the second compartment and one of the electrodes is cylindrical, according to some embodiments of the present invention.

FIG. 4A: Schematic representation of the cross-sectional view of an electrochemical cell for use in the method according to various embodiments of the invention, before the deposition process.

FIG. 4B: Schematic representation of the cross-sectional view of an electrochemical cell for use in the method according to various embodiments of the invention, during the deposition process.

FIG. 5: Deposition rates of cathodic electrophoretic deposition of LTO and anodic electrophoretic deposition of LFP on Ni and Celgard membrane (full triangles—LTO on Ni; full circles—LFP on Ni; hollow triangles LTO on Celgard membrane; hollow circles—LFP on Celgard membrane).

FIGS. 6A-6B: Photographs of the electrochemical cell (assembled—FIG. 6A and disassembled—FIG. 6B), the cell being used for concurrent EPD process of the MEA electrodes.

FIG. 7A: Photograph of the membrane electrode assembly prepared by concurrent EPD process.

FIG. 7B: Cross-sectional Environmental Scanning Electron Microscopy (ESEM) view of the membrane electrode assembly prepared by simultaneous EPD.

FIGS. 8A-8C: Planar ESEM micrographs of the LFP films electrophoretically deposited on Ni (FIG. 8A), and Celgard (FIGS. 8B and 8B), wherein FIG. 8B shows anodic deposition of a single electrode and FIG. 8C shows cathodic deposition in a concurrent EPD process.

FIGS. 9A-9C: Planar ESEM micrographs of the LTO films electrophoretically deposited on Ni (FIG. 9A), and Celgard (FIGS. 9B and 9B), wherein FIG. 9B shows cathodic deposition of a single electrode and FIG. 9C shows anodic deposition in a concurrent EPD process.

FIGS. 10A-10C: Lateral distribution of PEI (FIG. 10A), LFP (FIG. 10B), and their combination (FIG. 10C) in the membrane electrode assembly measured by Time-of-Flight Secondary Ion Mass Spectrometry (TOF-SIMS).

FIGS. 11A-11C: Lateral distribution of PEI (FIG. 11A), PAA (FIG. 11B), and their combination (FIG. 11C) in the membrane electrode assembly measured by TOF-SIMS.

FIGS. 12A-12C: Lateral distribution of PAA (FIG. 12A), LTO (FIG. 12B), and their combination (FIG. 12C) in the membrane electrode assembly measured by TOF-SIMS.

FIGS. 13A-13E: Cross-sectional tilted images of the MEA constituents simultaneously deposited on the opposite sides of the membrane, including Ti distribution in LTO anode (FIG. 13A), Fe distribution in the LFP cathode (FIG. 13B), Lithium distribution in the LTO anode and the LFP cathode (FIG. 13C), Overlapping of the images of FIGS. 13A, 13B and 13C (FIG. 13D), and Distribution of PLA and PEI polymers in the in LTO anode and the LFP cathode (FIG. 13E), measured by TOF-SIMS.

FIG. 14A-14C: Charge/discharge voltage profiles of half-coin cells and full-coin cell with electrophoretically deposited on-membrane electrodes (FIG. 14A shows a half-coin cell containing LFP/Celgard vs Li, FIG. 14B shows a half-coin cell containing LT/Ni vs Li, and FIG. 14C shows a full-coin cell containing LFP/Celgard/LTO MEA (solid line—0.5 C-rate; dashed line—1 C-rate).

FIG. 14D: Cycle life of the coin cell comprising LFP/Celgard/LTO MEA and LiPF₆ EC:DEC electrolyte (triangles—efficiency; circles—charge; squares—discharge).

FIG. 15A: Scanning Electron Microscopy (SEM) image at ×4,000 magnification of a graphite anode deposited on one side of the GE Whatman glass microfiber membrane.

FIG. 15B: Scanning Electron Microscopy (SEM) image at ×40,000 magnification of the graphite anode deposited on one side of the GE Whatman glass microfiber membrane.

FIG. 15C: Charge/discharge plot of a coin cell comprising graphite anode deposited on one side of the GE Whatman glass microfiber membrane (hollow circles—charge, full squares—discharge).

FIG. 15D: Cycle life of the coin cell comprising graphite anode deposited on one side of the GE Whatman glass microfiber membrane (full circles—charge, hollow squares—discharge).

FIG. 16A: ESEM micrograph at ×1,000 magnification of a silicon anode deposited on one side of the GE Whatman glass microfiber membrane.

FIG. 16B: ESEM micrograph at ×10,000 magnification of the silicon anode deposited on one side of the GE Whatman glass microfiber membrane.

FIG. 17: Charge/discharge plot of a coin cell comprising LMO anode deposited on one side of the GE Whatman glass microfiber membrane (full circles—charge, hollow squares—discharge).

FIG. 18A: ESEM micrograph at ×8,000 magnification of a graphite anode deposited on Electrolock glass fiber membrane (planar view).

FIG. 18B: ESEM micrograph at ×16,708 magnification of the graphite anode deposited on Electrolock glass fiber membrane (cross-sectional view).

### DETAILED DESCRIPTION OF THE INVENTION

The present invention provides a method for the fabrication of an electrode membrane assembly by electrophoretic deposition, wherein the first electrode of the MEA is formed on the first membrane surface and the second electrode is formed on the second, opposite, membrane surface, said processes proceeding in parallel. Further provided are the MEAS obtainable by said method and electrochemical cells enabling the concurrent deposition. The present invention overcomes the previously reported difficulty associated with the use of oppositely charged precursor particles, which are required in order to deposit two electrodes simultaneously. The method of the present invention provides MEAs, which efficiencies are comparable to the state-of-the-art MEAs prepared by a more complicated and time-consuming multi-step fabrication process.

In one aspect the present invention provides a method for electrophoretic deposition of a membrane-electrode assembly comprising a first electrode and a second electrode. The electrodes of the membrane-electrode assembly are also termed herein “first MEA electrode” and “second MEA electrode”. The membrane of the MEA is an electrically insulating ion-permeable membrane having two opposed surfaces comprising a first surface and a second surface. The method comprises electrophoretically depositing the first MEA electrode on the first surface of the membrane and the second MEA electrode on the second surface of the membrane. The first MEA electrode is being deposited from a first suspension comprising a first precursor and the second electrode is being deposited from a second suspension comprising a second precursor. The first precursor is physically separated from the second precursor. The first precursor is further ionically connected to the second precursor.

The terms “ion-permeable”, “ion-conducting” and “ion-conductive” are used herein interchangeably.

The terms “ionically connected” and “ionic contact”, which are used herein interchangeably, refer to the exposure of the first precursor and the second precursor to a liquid phase, in which ions can freely move between the first precursor and the second precursor.

Typically, the first suspension comprises the first precursor suspended in a liquid electrolyte and/or the second suspension comprises the second precursor suspended in a liquid electrolyte.

According to various embodiments of the invention, the membrane is not permeable to the first precursor and to the second precursor. In certain such embodiments, the first precursor is physically separated from the second precursor by said membrane. The physical separation between the first precursor and the second precursor by the membrane can be assisted or enhanced by the use of gaskets or sealants, as known in the art.

Typically, the membrane is a thin film, meaning that its thickness is at least 10 times smaller than its length or width. The membrane can have any thickness, which is sufficient to block the first precursor and the second precursor from penetration therethrough, while still maintaining ionic passage of certain ions present in the suspension and/or allowing sufficient wetting thereof. According to some embodiments, the membrane has a thickness ranging from about 5 μm to about 1000 μm. In further embodiments, the membrane has a thickness ranging from about 5 μm to about 500 μm. In yet embodiments, the membrane has a thickness ranging from about 5 μm to about 100 μm. In some exemplary embodiments, the thickness of the membrane ranges from about 10 μm to about 40 μm.

The membrane can have any shape as long as it comprises at least two opposed surfaces on which the MEA electrodes can be deposited.

The membrane can have a two-dimensional shape, e.g., a sheet. In further embodiments, said sheet physically separates the first precursor from the second precursor in step (ii), while providing ionic contact therebetween.

The membrane can have a three-dimensional hollow shape, suitable for holding precursors and/or enclosing an EPD electrode. In some embodiments, the membrane is in a form of a receptacle or sleeve. In some related embodiments, the receptacle or sleeve is at least partially sealed. In certain embodiments, the sealed end contacts the suspensions containing the first precursor and the second precursor. The receptacle or sleeve can have, inter alia, a rectangular, square, circular, oval or any irregularly shaped cross-section. For example, the membrane can be in a form of a tubular receptacle with a sealed bottom end. In other embodiments, the membrane is in a form of a sleeve composed of two rectangular sheets sealed on three ends thereof, leaving the fourth end open for the insertion of an EPD electrode. The open end does not contact the suspensions containing the first and the second precursors. For example, the open end can be raised above the liquid level. The sleeve can contain a suspension containing the first precursor or, alternatively, a suspension comprising the second precursor. The sleeve can further comprise an EPD electrode. In certain embodiments, the method comprises depositing the MEA electrodes on opposed surfaces of a certain portion of the membrane (receptacle or sleeve) and not on the entire surface thereof. Without wishing to being bound by theory or mechanism of action, the geometrical area and/or shape of the deposited MEA electrodes depends, inter alia, on the placement of the EPD electrodes relatively to the membrane.

In some embodiments, the geometrical area of each of the first surface and the second surface of the membrane ranges from, but is not limited to about 0.025 to about 1000 cm². The membrane can be, inter alia, rectangular, square, round, or oval, or have any irregular shape, as known in the art. The membrane can be patterned, with different shape of patterns varying by size. In some related embodiments, the membrane has a roughness

According to some embodiments, the membrane is a porous separator. The term “porous separator”, as used herein, refers to a material that is capable of insulating oppositely charged electrodes of the EPD cell from each other electrically but has open pores through which electrolyte ions can pass from one electrode to the other.

The porous separator can be micro-porous or nano-porous. According to some embodiments, the mean pore size of the porous separator ranges from about 0.01 to about 10 μm. In further embodiments, the mean pore size of the porous separator ranges from about 0.05 to about 7.5 μm. In yet further embodiments, the mean pore size of the porous separator ranges from about 0.1 to about 5 μm. In yet further embodiments, the mean pore size of the porous separator ranges from about 0.5 to about 2.5 μm. In certain embodiments, the porous separator has a mean pore size ranging from about 0.02 to about 0.1 μm. In additional embodiments, the porous separator has a mean pore size ranging from about 0.1 to about 0.5 μm.

The term “pore size”, as used herein, refers to the size of a pore in the largest dimension thereof. In some embodiments, wherein the pore is essentially spherical, the term “pore size” refers to the pore diameter. The term “mean pore size” as used herein means that half the open volume of the material is contained in pores larger in diameter than the mean pore size, and half is contained in pores equal to or smaller than the mean pore size. The mean pore size of the membrane and/or the porous separator can be measured as known in the art. e.g., by at least one of the Bubble Gas Transport Method, Mercury Intrusion Porosimetry, Adsorption-Desorption Method (Barett-Joyner-Halenda (BJH) Method), Gas Liquid Equilibrium Method (Permporometry), Liquid Displacement Permporometry (LPD), Diffusional Permoporometry (DP), and Electron microscopy.

In some embodiments, the porosity of the porous separator ranges from about 10% to about 90%. In further embodiments, the porosity of the porous separator ranges from about 20% to about 75%. In certain embodiments, the porous separator has porosity ranging from about 30% to about 55%.

The term “porosity” as used herein, refers, in some embodiments, to the void volume fraction of the membrane and/or the porous separator and is defined as the volume of the pores divided by the total volume of the membrane and/or the porous separator.

In some embodiments, effective porosity of the porous separator ranges from about 10% to about 90%. In further embodiments, the effective porosity of the porous separator ranges from about 20% to about 75%. In certain embodiments, the effective porous separator has porosity ranging from about 30% to about 55%.

The term “effective porosity”, as used herein, refers to a porosity of a membrane and/or porous separator in which the voids are not open at both ends of said membrane or separator, and is defined as the ratio of the connected pore volume to the total void volume.

Porosity can be measured as known in the art, e.g., by mercury intrusion or gas adsorption. Effective porosity can be measured by capillary flow method using, e.g., Capillary Flow Porometer.

According to some embodiments, the membrane comprises a plurality of porous separators. In further embodiments, the membrane comprises at least a first porous separator and a second porous separator stacked together such that a second surface of the first separator contacts a first surface of the second separator. The first and the second porous separators can be positioned such that the mean pore size and/or the effective porosity of the first and the second porous separators stacked together is lower than that of each one of the first porous separator and the second porous separator. For example, porous separators having through pores (i.e., voids are open at both ends of the separator) can be misaligned such that the pores of the adjacent separators do not coincide and the number of the pores which are open on both sides of the plurality of separators (e.g., on the first surface of the first porous separator and on the second surface of the second porous separator) is smaller than the number of pores which is open on both sides of each of the first porous separator and the second porous separator. Without wishing to being bound by theory or mechanism of action, it is contemplated that in such way porous separators which have a higher mean pore size than the mean particle size of the precursor colloidal particles can be used. The porous separator can be selected from a polymer separator, ceramic separator, zeolite separator, glass separator, and combinations thereof.

In some exemplary embodiments, the separator is a polymer separator. Various polymers can be utilized in the porous separators of electrochemical devices, as known in the art. The most common types of such polymers include, inter alia, polyolefins, fluoropolymers, and chloropolymers. Non-limiting examples of polymers suitable for use in the porous separator of the method according to the principles of the present invention are polyethylene (PE), polypropylene (PP), poly (tetrafluoroethylene) (PTFE), polyvinyl chloride (PVC), polyvinylidene difluoride (PVDF), polymethyl methacrylate, and combinations thereof.

According to some embodiments, the porous separator is a polyolefin. In further embodiments, the porous separator is made of PE, PP or a combination thereof. The porous separator can contain one, two, three, or more polymer layers. The different layers can have the same or different properties, e.g., chemical composition, porosity, permeability, thickness, and the like.

In some exemplary embodiments, the porous separator comprises a PP/PE/PP trilayer separator. These porous separators are commercially available under the trade name Celgard®, including, inter alia, Product Nos. 2325, 2340, C500, C480, 2320, C300, C250, C200, C212, M825, M824, having varying thicknesses, porosities and mechanical properties. In certain embodiments, the PP/PE/PP trilayer separator has porosity ranging from about 30% to about 55%. In further embodiments, the mean pore size of the PP/PE/PP trilayer separator ranges from about 0.02 to about 0.1 μm. In yet further embodiments, the PP/PE/PP trilayer separator has a thickness ranging from about 10 to about 100 μm.

Monolayer porous separators, comprising, e.g., PP, are also within the scope of the present invention, including, inter alia, Celgard® 2400, 2500 A273. The monolayer PP separators can further be coated, laminated to PP nonwoven fabric, or both.

According to certain embodiments, the porous separator is a glass microfiber separator.

The porous separator is typically filled by a suitable liquid, semi-solid, gel, or solid electrolyte, to enable its functioning in the electrochemical device. During the EPD process according to the principles of the present invention, the porous separator is filled by the electrolyte of the first suspension and/or of the second suspension, thereby ensuring wetting of the separator and the ionic contact between the first precursor and the second precursor.

According to some embodiments, the membrane is an ion exchange membrane. The term “ion exchange membrane”, as used herein, refers to a membrane comprising chemical groups capable of combining with ions or exchanging ions between the membrane and an external medium. The chemical groups can be in a form of a salt, an acid or a base, wherein the cations, anions, protons or hydroxyl ions thereof are exchangeable with other cations, anions, protons or hydroxyl ions from an external source, e.g., a solution or gas. Ion exchange membranes can be provided in an acid form and converted to a salt form by pretreating the membrane with a base, such as an alkali metal salt or an alkaline earth metal salt or in an alkaline form, being thereafter converted to a salt by pretreating the membrane with a suitable acid.

In some embodiments, the ion exchange membrane is a resin, such as a polymer containing exchangeable ions. The resin can further comprise a composite or a mixture of polymers, or a mixture of polymers and other components, to provide a contiguous membrane material. In certain embodiments, the membrane material can comprise two or more layers. The different layers can have the same or different properties, e.g., chemical composition, porosity, permeability, thickness, and the like. In certain embodiments, it can also be desirable to employ a layer, e.g., a membrane that provides support to the porous membrane, or possesses some other desirable property.

The ion exchange membranes can be divided into two major groups, based on the polarity of the ions, which they conduct, i.e., anion exchange membranes (AEMs) and cation exchange membranes (CEMs).

AEMs can be described as polymer electrolytes that conduct anions, such as, for example, Cl⁻, as they contain positively charged (cationic) groups, typically bound covalently to a polymer backbone. These cationic functional groups can be bound either via extended side chains (alkyl or aromatic types of varying lengths) or directly onto the backbone (often via CH₂ bridges); or can be an integral part of the backbone. Non-limiting examples of suitable AEM types include non-alkaline anion exchange membrane, alkaline anion exchange membrane (AAEM), hydroxide-exchange membrane (HEM), anion-exchange ionomer membrane (AEI), and combinations thereof. The polymer backbones suitable for use in the AEM include, inter alia, poly(arylene ethers) of various chemistries, such as polysulfones (including cardo, phthalazinone, fluorenyl, and organic-inorganic hybrid types), poly(ether ketones), poly(ether imides) poly(ether oxadiazoles), and poly(phenylene oxides) (PPO); polyphenylenes, perfluorinated types, polybenzimidazole (PBI) types including where the cationic groups are an intrinsic part of the polymer backbones, poly(epichlorohydrins) (PECH), unsaturated polypropylene and polyethylene types, including those formed using ring opening metathesis polymerisation (ROMP), those based on polystyrene, poly(styrene/divinyl benzene) (PS/DVB), and poly(vinylbenzyl chloride), polyphosphazenes, radiation-grafted types, those synthesized using plasma techniques, pore-filled types, electrospun fiber types, PTFE-reinforced types, and those based on poly(vinyl alcohol) (PVA). Non-limiting examples of suitable cationic groups include amines, quaternary ammoniums (QA) such as, for example, benzyltrialkylammoniums; heterocyclic systems including imidazolium, benzimidazoliums, PBI systems where the positive charges are on the backbone (with or without positive charges on the side-chains), and pyridinium types; guanidinium systems (e.g., pentamethylguanidinium groups); P-based systems types including stabilized phosphoniums (e.g. tris(2,4,6-trimethoxyphenyl)phosphonium and P-N systems such as phosphatranium and tetrakis(dialkylamino)phosphonium systems; sulfonium types; and metal-based systems where an attraction is the ability to have multiple positive charges per cationic group.

CEMs can be described as polymer electrolytes that conduct cations, such as, for example, Na⁺, as they contain negatively charged (anionic) groups, typically bound covalently to a polymer backbone. Non-limiting examples of suitable CEM types include non-acidic cation exchange membrane, proton-exchange membrane (PEM), cation-exchange ionomer membrane, and combinations thereof. The polymer backbones suitable for use in the CEM include, inter alia, fluorine-containing polymer, e.g., polyvinylidene fluoride, polytetrafluoroethylene (PTFE), ethylene tetrafluoride-propylene hexafluoride copolymers (FEP), ethylene tetrafluoride-perfluoroalkoxyethylene copolymers (PFE), polychlorotrifluoroethylene (PCTFE), ethylene tetrafluorideethylene copolymers (ETFE), polyvinylidene fluoride, polyvinyl fluoride, vinylidene fluoride-trifluorinated ethylene chloride copolymers, vinylidene fluoride-propylene hexafluoride copolymers, vinylidene fluoridepropylene hexafluoride-ethylene tetrafluoride terpolymers, ethylene tetrafluoride-propylene rubber, fluorinated thermoplastic elastomers; sulfonated fluoropolymers; sulfonated poly(ether ether ketone); polysulfone; poly(styrene/divinyl benzene (PS/DVB); polyethylene; polypropylene; ethylene-propylene copolymer; polyimide; and polyvinyldifluoride. Non-limiting examples of suitable anionic groups include sulfite, carboxy, phosphite, arsenic, and selenic groups, phenols, and salts thereof

According to some embodiments, the ion exchange membrane is a perfluorinated ionomer comprising a copolymer of ethylene and a vinyl monomer containing an acid group or salts thereof. Non-limiting examples of perfluorinated ionomers include perfluorosulfonic acid/tetrafluoroethylene copolymers (“PFSA-TFE copolymer”) and perfluorocarboxylic acid/tetrafluoroethylene copolymer (“PFCA-TFE copolymer”). These membranes are commercially available under the trade names Nafion® (E.I. du Pont de Nemours & Company), FLEMION® (Asahi Glass Company, Ltd), and ACIPLEX® (Asahi Chemical Industry Company). Additionally, lithium ion-conducting membranes, like lithium aluminate, LISICON, thio-LISICON, Li10GeP2S12, Li10TiP2S12 and Li10SnP2S12, argyrodite, garnet, NASICON, Li-nitride, Li-hydride, perovskite, and Li halide and Na halide can be used.

In order to enable the EPD process according to the principles of the present invention, the ion exchange membrane should be capable of conducting of certain ions of the electrolyte of the first suspension and/or the second suspension, thereby ensuring the ionic contact between the first precursor and the second precursor.

As mentioned hereinabove, the first precursor and/or the second precursor can be suspended in a liquid electrolyte. In some embodiments, the first precursor, the second precursor or both are in a form of colloidal particles suspended in the liquid electrolyte. The liquid electrolyte of the first suspension and of the second suspension can be the same or different.

The terms “electrolyte” or “liquid electrolyte”, as used herein, refer to an aqueous or non-aqueous fluid in which conducting ions are disposed.

The liquid electrolyte can be aqueous or organic and should provide wetting of the membrane. The type of the electrolyte can be selected based on the desired composition of the MEA electrodes, the type of the membrane or the type of the EPD process. In some embodiments, the liquid electrolyte is selected from water; ketones, e.g., acetone and acetyl acetone; aromatic compounds, e.g., benzene and toluene; alcohols, e.g., methanol, ethanol, isopropyl alcohol, and 1,4-butanediol; dichloromethane, glacial acetic acid, and combinations thereof. In some exemplary embodiments, the electrolytes of the first suspension and of the second suspension comprise acetone and acetyl acetone. In some embodiments, the electrolyte is an aqueous electrolyte.

According to some embodiments, the suspension and/or the electrolyte further comprises ions, which enhance ionic strength and conductivity of the suspension. Said ions are configured to penetrate the membrane to sustain the electric field across the electrochemical cell, in which the deposition of the first MEA electrode and the second MEA electrode takes place. Accordingly, in some embodiments, the ions are solvated. The term “solvated ion” refers to a soluble ion in an ionic solution. Typically, the solvation of an ion depends on the electrostatic attraction of solvent molecules to said ion, based on said ion density of charge. In some embodiments, the membrane is an ion exchange membrane, which is configured to conduct said specific ion(s). According to some embodiments, the concentration of the ions in the suspension ranges from about 10 ppm to about 1 mM.

The electrolyte can further be acidic or alkaline, i.e., containing protons or hydroxyl ions. In some embodiments, the electrolyte further comprises at least one of sulfuric acid, hydrochloric acid, perchloric acid, trifluoromethanesulfonic acid, nitric acid, benzoic acid, iodine, sodium hydroxide, potassium hydroxide, ammonium hydroxide, and tetramethylammonium hydroxide (TMAH).

According to some embodiments, the pH of the electrolyte of the first suspension ranges from about 6 to about 10. According to some embodiments, the pH of the electrolyte of the second suspension ranges from about 5 to about 9.

The electrolyte can further include a dissolved salt, such as but not limited to ammonium chloride, sodium chloride, magnesium chloride, nickel chloride, ammonium nitrate, sodium nitrate, magnesium nitrate, nickel nitrate, and any combination thereof.

The loading of the colloidal particles in the liquid electrolyte can range from about 0.1 mg/ml to about 50 mg/ml. In some embodiments, the loading of the colloidal particles in the liquid electrolyte ranges from about 0.5 mg/ml to about 10 mg/ml. In further embodiments, the loading of the colloidal particles in the liquid electrolyte ranges from about 1 mg/ml to about 7 mg/ml. In yet further embodiments, the loading of the colloidal particles in the liquid electrolyte ranges from about 2 mg/ml to about 5 mg/ml.

Preferably, the colloidal particles of the first precursor, of the second precursor or both have a mean particle size, which is larger than the mean pore size of the membrane. In some embodiments, the colloidal particles of the first precursor, of the second precursor or both have a mean particle size, which is at least about 5% larger than the mean pore size of the membrane. In further embodiments, the mean particle size of the colloidal particles of the first precursor, of the second precursor or both is at least about 10%, at least about 15%, at least about 20%, at least about 30%, at least about 40%, at least about 50%, at least about 60%, at least about 70%, at least about 80% larger, at least about 90%, or at least about 100% larger than the mean pore size of the membrane. Each possibility represents a separate embodiment of the invention. According to some embodiments, the colloidal particles of the first precursor, of the second precursor or both have a mean particle size, which is at least about two-fold larger than the mean pore size of the membrane. According to further embodiments, the colloidal particles of the first precursor, of the second precursor or both have a mean particle size, which is at least about three-fold larger than the mean pore size of the membrane. According to yet further embodiments, the colloidal particles of the first precursor, of the second precursor or both have a mean particle size, which is at least about five-fold larger than the mean pore size of the membrane. According to still further embodiments, the colloidal particles of the first precursor, of the second precursor or both have a mean particle size, which is at least about ten-fold larger than the mean pore size of the membrane.

The term “particle size”, as used herein, refers to the length of the particle in the longest dimension thereof.

Colloidal particles can be monodisperse or polydisperse. The term “mean particle size” can refer to the size of monodisperse particles or polydisperse particles. The term “mean particle size”, as used herein, refers in some embodiments, to an equivalent spherical diameter as determined by laser light diffraction scattering (or dynamic light scattering). In some embodiments, the term “mean particle size” refers to an arithmetic average of particle sizes as measured by conventional particle size measuring techniques well known to those skilled in the art, such as sedimentation field flow fractionation, photon correlation spectroscopy, disk centrifugation, transmission electron microscopy or scanning electron microscopy. In other embodiments, said term refers to the arithmetical average of sizes of a certain portion of particles within said polydisperse particles, wherein said portion constitutes at least 10% of the total amount of polydisperse particles, at least about 20%, at least about 30%, at least about 40% or at least about 50% of the total amount of polydisperse particles. Each possibility represents a separate embodiment of the invention.

In some embodiments, the mean particle size of the colloidal particles ranges from about 0.05 μm to about 10 μm. In further embodiments, the mean particle size of the colloidal particles ranges from about 0.1 μm to about 7.5 μm. In yet further embodiments, the mean particle size of the colloidal particles ranges from about 0.5 μm to about 5 μm. The colloidal particle can be made up from an aggregation of different particles, powders, beads, nanotubes, nanowires, nanofibers, microfibers, or other nano- or micro-structures.

The colloidal particles of the first precursor and of the second precursor can have any shape, such as, but not limited to, spherical, oval, ellipsoid, polygon, or irregular shape.

In some embodiments, the first precursor is chemically distinct from the second precursor. Such combination of the precursors is suitable for preparing MEAs for use, inter alia, in batteries, fuel cells, flow cells, asymmetrical supercapacitors, and photoelectrochemical cells. In some embodiments, the first precursor is chemically similar to the second precursor. The combination of similar precursors is particularly suitable for the preparation of MEAs for symmetrical supercapacitors.

According to some currently preferred embodiments, the first precursor and the second precursor have opposite polarities. The method according to the principles of the present invention employs opposite polarities of precursors to move the precursors in opposite directions within the electrochemical cell, thereby inducing deposition of the first precursor on one side of the membrane as the first MEA electrode and deposition of the second precursor on the opposite side of the membrane as the second MEA electrode. Without wishing to being bound by theory or mechanism of action, polarity of the first precursor and the second precursor can be changed based on the materials which make up said precursors, such as, for example, electrode active materials. In certain embodiments, wherein the electrode active materials are not or cannot be charged, addition of a charging agent to the precursor is required to form charged colloidal particles. The charge of the first and the second precursor can be further induced by the composition of the electrolyte, e.g., the electrolyte being acidic or alkaline. Varying the pH of the electrolyte can, inter alia, induce the charge of the charging agent being the part of the precursor. For example, when the charging agent is a polyelectrolyte, varying the pH induces dissociation of cationic and anionic groups of the polyelectrolyte, resulting in the charging of the polymer. The electrolyte can further include ingredients, which adsorb on the precursor colloidal particles. Without further wishing to being bound by theory or mechanism of action, the charge of the precursors can be easily manipulated, and the same electrode active material can be made to have opposite polarities, depending on the desired type of the EPD process (i.e., cathodic or anodic), thereby dictating the side of the membrane on which the respective MEA electrode will be deposited.

According to some embodiments, zeta potential of the colloidal particles is at least about −85 mV. Without wishing to being bound by theory or mechanism of action, it is contemplated that zeta potential should preferably be kept above the indicated minimal value to enable precursor movement towards the membrane as a result of applied electric field. According to further embodiments, zeta potential of the colloidal particles ranges between about −85 mV and +65 mV. According to yet further embodiments, zeta potential of the colloidal particles ranges between about −75 mV and +55 mV, from about −65 mV and +45 mV, or from about −45 mV and +35 mV. Each possibility represents a separate embodiment of the invention.

According to some embodiments, the first precursor comprises a first electrode active material. According to some embodiments, the second precursor comprises a second electrode active material. The term “electrode active material”, as used herein, refers a material that may generate or receive electrons, or alternatively, a material that may be oxidized or reduced, or alternatively, a material capable of reversibly incorporating and releasing chemical species serving as charge carriers, in an electrochemical device.

In some embodiments, the first electrode active material is distinct from the second electrode active material. Two distinct types of electrode active materials are typically used for the preparation of MEAs for use in batteries, fuel cells, flow cells, asymmetrical supercapacitors, or photoelectrochemical cells. In some embodiments, the first electrode active material is identical to the second electrode active material. The combination of similar electrode active materials is particularly suitable for the preparation of MEAs for symmetrical supercapacitors.

In some embodiments, the first MEA electrode functions as a cathode and the second MEA electrode functions as an anode in the designated electrochemical device.

The first electrode active material can be a Li-ion battery cathode active material. In some embodiments, the first electrode active material comprises a lithiated active material. Such lithiated active material can be, for example, lithiated metal oxide. Non-limiting examples of suitable lithiated metal oxides include LiFePO₄, LiMnPO₄, LiCoPO₄, LiCoO₂, LiNiO₂, Li(Al,Ni,Mn)O₂, LiMnO₂, LiMn₂O₄, Li₂MnO₃, LiNiMnCoO, and combinations thereof. In some exemplary embodiments, the first electrode active material comprises LiFePO₄.

The second electrode active material can be a Li-ion battery anode active material. Non-limiting examples of suitable materials include lithium titanate (Li₄Ti₅O₁₂), graphitic carbon, disordered carbon, tin oxide, indium tin oxide, vanadium oxide, manganese oxide, chromium oxide, iron oxide, nickel oxide, cobalt oxide, lithium-silicon, tin-cobalt, silicon, aluminum, zinc, tin, silver, antimony, bismuth, and combinations thereof. Said disordered carbon can be provided in a form of meso-carbon micro-beads (MCMB), or nanotubes.

In some embodiments, the first electrode active material, the second active electrode material or both comprise a fuel cell or flow cell electrode active material. The fuel cell or flow cell electrode active material can be selected, inter alia, from carbon, metal, metal carbide, metal nitride, metal oxide, transition metal chalcogenide, transition metal macrocyclic compounds, conducting polymer, and combinations thereof.

The carbon can be provided in a form of graphitic carbon, activated carbon, carbon black, carbon beads, carbon fibers, carbon microfibers, carbon cloth, carbon paper, fullerenic carbons, carbon nanotubes (CNTs), including multiwall carbon nanotubes (MWCNTs) and single wall carbon nanotubes (SWCNTs), graphene sheets or aggregates of graphene sheets, and materials comprising fullerenic fragments. Carbon electrode active material is typically used in supercapacitors and capacitive deionization sells.

Non-limiting examples of suitable metals include Pt, Pd, Ru, Au, Ag, Ir, Rh, Re, Cu, Ce, Cd, Zn, Fe, Mo, Ni, Co, Cr, Al, and alloys, and combinations thereof. The metal or metal alloy can be supported on carbon, wherein said carbon can have any form as disclosed hereinabove. Metal and metal alloy electrode active materials are typically used for the preparation of fuel cell or flow cell MEAs.

Non-limiting examples of conducting polymers, which can be used as electrode active materials according to the principles of the present invention include polyaniline, polypyrrole, viologens, dilithium (2,5-dilithium-oxy)-terephthalate, polyimides and polyquinones, poly(3-vinyl-N-methylphenothiazine), C₆O₆Li₂, 5,7,12,14-pentacenetetrone, and 1,10-phenanthroline-5,6-dione.

According to additional embodiments, the first electrode active material, the second active electrode material or both comprise a supercapacitor electrode active material. The supercapacitor electrode active material can be selected, inter alia, from carbon, metal, metal phosphate, metal nitride, metal oxide, transition metal chalcogenide, conducting polymer, and combinations thereof.

Carbon can be provided in a form of graphitic carbon, activated carbon, carbon black, carbon beads, carbon fibers, carbon microfibers, carbon cloth, carbon paper, fullerenic carbons, carbon nanotubes (CNTs), including multiwall carbon nanotubes (MWCNTs) and single wall carbon nanotubes (SWCNTs), graphene sheets or aggregates of graphene sheets, and materials comprising fullerenic fragments.

Non-limiting examples of suitable metal oxides include MnₙOₓ, TiOₓ, NiOₓ, CoOₓ, SnOₓ, and combinations thereof, wherein x ranges from 1.5 to 3. Non-limiting examples of suitable transition metal chalcogenides include FeS_{y}, MoS_{y}, NiS_{y}, CoS_{y}, MnS_{y}, TiS_{y}, SnS_{y} and combinations thereof, wherein y ranges from 1.8 to 2.2 and n ranges from 1 to 2. One non-limiting example of a suitable metal phosphate is Li(Ti₂(PO₄)₃.

According to some embodiments, the first precursor comprises from about 30% (w/w) to about to about 100% (w/w) of the first electrode active material. In further embodiments, the first precursor comprises from about 60% (w/w) to about to about 99% (w/w) of the first electrode active material. In yet further embodiments, the first precursor comprises from about 70% (w/w) to about to about 95% (w/w) of the first electrode active material. In still further embodiments, the first precursor comprises from about 80% (w/w) to about to about 90% (w/w) of the first electrode active material. In some related embodiments, the first electrode active material is a Li-ion battery cathode active material. In further related embodiments, the first electrode active material is a fuel cell or flow cell electrode active material. In additional related embodiments, the first electrode active material is a supercapacitor electrode active material.

According to some embodiments, the second precursor comprises from about 30% (w/w) to about to about 100% (w/w) of the electrode active material. In further embodiments, the second precursor comprises from about 60% (w/w) to about to about 99% (w/w) of the second electrode active material. In yet further embodiments, the second precursor comprises from about 70% (w/w) to about to about 95% (w/w) of the second electrode active material. In still further embodiments, the second precursor comprises from about 80% (w/w) to about to about 90% (w/w) of the second electrode active material. In some related embodiments, the second electrode active material is a Li-ion battery anode active material. In further related embodiments, the second electrode active material is a fuel cell or flow cell electrode active material. In additional related embodiments, the second electrode active material is a supercapacitor electrode active material.

As mentioned hereinabove, the first precursor, the second precursor or both can further comprise a charging agent. The charging agent can enhance surface charge (i.e., zeta potential) of the colloidal particles of the precursor. Typically, the charging agent has a positive or negative charge or can have a positive or negative charge at a certain pH. Accordingly, the type and, in particular, the polarity of the charging agent can be selected based on the desired EPD process (i.e., anodic or cathodic) and the side of the membrane on which the precursor is to be deposited in a given electrochemical cell. The pH of the electrolyte can further be varied to control charging of the charging agent and the overall charge of the precursor.

In some currently preferred embodiments, the charging agent comprises a polyelectrolyte. One of the essential features of the polyelectrolyte in the context of the present invention is its relatively large size which prevents its penetration through the membrane. The polyelectrolyte can have cationic or anionic groups. The polyelectrolytes can include, inter alia, polyacrylamide, carboxyl-, sulfur-, or phosphorous-containing polyelectrolytes Non-limiting examples of specific suitable polyelectrolytes include poly(acrylic acid) (PAA), polyethyleneimine (PEI), polydiallyldimethylammonium (PDDA), and polystyrene sulfonic acid (PSS).

The charging agent can further serve as a binder in the first MEA electrode, in the second MEA electrode, or both. Two or more polyelectrolytes can be combined to achieve the desired zeta potential of the precursors, as well as to control the mechanical and conductive properties of the electrodes to be formed, in particular when the charging agent serves also as a binder. For example, at a certain pH, a first polyelectrolyte can function as a charging agent (e.g., PEI in a neutral or slightly alkaline medium in the presence of acetyl acetone) and a second polyelectrolyte can function as a binder (e.g., PAA in the said medium of PEI). It is to be understood, that the term “charging agent” refers to a material having a positive or negative charge, when disposed in the electrolyte of the respective suspension.

In some exemplary embodiments, the first precursor comprises a combination of PEI and PAA. In certain embodiments, the PEI is a branched PEI. In further exemplary embodiments, the second precursor comprises PAA.

According to some embodiments, the first precursor comprises from about 0.001% (w/w) to about to about 10% (w/w) of the charging agent. In further embodiments, the first precursor comprises from about 0.005% (w/w) to about to about 5% (w/w) of the charging agent. In yet further embodiments, the first precursor comprises from about 0.01% (w/w) to about to about 1% (w/w) of the charging agent. In still further embodiments, the first precursor comprises from about 0.05% (w/w) to about to about 1% (w/w) of the charging agent. In some related embodiments, the charging agent is an anionic polyelectrolyte.

According to some embodiments, the second precursor comprises from about 0.01% (w/w) to about to about 20% (w/w) of the charging agent. In further embodiments, the second precursor comprises from about 0.1% (w/w) to about to about 15% (w/w) of the charging agent. In yet further embodiments, the second precursor comprises from about 1% (w/w) to about to about 7% (w/w) of the charging agent. In still further embodiments, the second precursor comprises from about 2.5% (w/w) to about to about 10% (w/w) of the charging agent. In some related embodiments, the charging agent is a cationic polyelectrolyte.

According to some embodiments, the first precursor further comprises a binder, which is different from the charging agent of said precursor. According to some embodiments, the second precursor further comprises a binder, which is different from the charging agent of said precursor. Non-limiting examples of suitable binders include PAA, PVDF, polyacrylonitrile (PAN), poly-methyl methacrylate (PMMA), carboxymethyl cellulose (CMC).

According to some embodiments, the first precursor comprises from about 0.01% (w/w) to about to about 30% (w/w) of the binder. In further embodiments, the first precursor comprises from about 0.1% (w/w) to about to about 15% (w/w) of the binder. In yet further embodiments, the first precursor comprises from about 0.5% (w/w) to about to about 10% (w/w) of the charging agent. In still further embodiments, the first precursor comprises from about 1% (w/w) to about to about 30% (w/w) of the binder.

According to some embodiments, the second precursor comprises from about 0.01% (w/w) to about to about 30% (w/w) of the binder. In further embodiments, the second precursor comprises from about 0.1% (w/w) to about to about 20% (w/w) of the binder. In yet further embodiments, the second precursor comprises from about 0.5% (w/w) to about to about 10% (w/w) of the charging agent. In still further embodiments, the second precursor comprises from about 1% (w/w) to about to about 30% (w/w) of the binder.

The first precursor, the second precursor or both can further comprise a conducting agent. The conducting agent is typically added to enhance electric conductivity of the formed MEA electrodes, without interfering with the reactions taking place in the electrochemical device. Non-limiting examples of suitable conducting agents include carbon black, graphite, MCMB, single- and multiwall carbon nanotubes and metal nanoparticles.

According to some embodiments, the first precursor comprises from about 0.5% (w/w) to about to about 50% (w/w) of the conducting agent. In further embodiments, the first precursor comprises from about 1% (w/w) to about to about 35% (w/w) of the conducting agent. In yet further embodiments, the first precursor comprises from about 5% (w/w) to about to about 20% (w/w) of the conducting agent. In still further embodiments, the first precursor comprises from about 7.5% (w/w) to about to about 15% (w/w) of the conducting agent.

According to some embodiments, the second precursor comprises from about 0.5% (w/w) to about to about 50% (w/w) of the conducting agent. In further embodiments, the second precursor comprises from about 1% (w/w) to about to about 35% (w/w) of the conducting agent. In yet further embodiments, the second precursor comprises from about 5% (w/w) to about to about 20% (w/w) of the conducting agent. In still further embodiments, the second precursor comprises from about 7.5% (w/w) to about to about 15% (w/w) of the conducting agent. The first precursor, the second precursor or both can further comprise a dispersing agent, such as, for example sodium dodecyl sulfate or Triton X or any other surface-active agent.

In some exemplary embodiments, the first suspension comprises the first precursor comprising LiFePO₄, branched PEI, PAA, and carbon black. In further embodiments, the first precursor comprises: about 70-95% (w/w) LiFePO₄; about 0.01-1% (w/w) branched PEI; about 0.5-5% (w/w) PAA; and about 5-20% carbon black. In yet further embodiments, the first suspension further comprises acetone and acetylacetone as the liquid electrolyte. In still further embodiments, the pH of the liquid electrolyte ranges from about 5 to about 10. In certain embodiments, the pH of the liquid electrolyte ranges from about 6 to about 9. In some related embodiments, the loading of the first precursor in the liquid electrolyte ranges from about 1 to about 7 mg/ml.

In some exemplary embodiments, the second suspension comprises the second precursor comprising Li₄Ti₅O₁₂, PAA, and carbon black. In further embodiments, the second precursor comprises: about 70-95% (w/w) Li₄Ti₅O₁₂; about 1-7% (w/w) PAA; and about 5-20% carbon black. In yet further embodiments, the second suspension further comprises acetone and acetylacetone as the liquid electrolyte. In still further embodiments, the pH of the liquid electrolyte ranges from about 3 to about 7. In certain embodiments, the pH of the liquid electrolyte ranges from about 4 to about 6. In some related embodiments, the loading of the second precursor in the liquid electrolyte ranges from about 1 to about 7 mg/ml.

The first precursor can be formed by suspending the first electrode active material and, optionally, at least one of the charging agent, the binder, and the conducting agent, in the liquid electrolyte. Similarly, the second precursor can be formed by suspending the second electrode active material and, optionally at least one of the charging agent, the binder, and the conducting agent, in the liquid electrolyte. The pH of the liquid electrolyte can be further adjusted to induce charging of the charging agent. In some embodiments, the first precursor is formed by suspending the first electrode active material, and the charging agent, and optionally, the binder and/or the conducting agent, in the liquid electrolyte. In some exemplary embodiments, the first precursor is formed by suspending the first electrode active material, the charging agent, the binder and the conducting agent, in the liquid electrolyte. In some embodiments, the second precursor is formed by suspending the second electrode active material, and the charging agent, and optionally, the binder and/or the conducting agent, in the liquid electrolyte. In some exemplary embodiments, the second precursor is formed by suspending the second electrode active material, the charging agent, and the conducting agent in the liquid electrolyte.

Solid constituents of the precursor can be mixed together prior to suspending them in the liquid electrolyte. Alternatively, the solid constituents can be added separately and/or at different times (but prior to step (ii)). Typically, the solid constituents within the liquid electrolyte are assembled into the colloidal particles of the precursor, possibly as a result of electrostatic forces acting thereon, thereby forming the first suspension and the second suspension. The solid constituents of the first precursor and/or the second precursor, including the first electrode active material, the second electrode active material, the charging agent, the binder, and the conductive agent, can be obtained from a powder, or a plurality of nano- or micro-particles, beads, nanotubes, nanowires, nanofibers, microfibers, and other nano- or micro-structures.

The presently disclosed method concerns MEA preparation via electrophoretic deposition of two electrodes on an insulating membrane. According to some currently preferred embodiments, the deposition of the first MEA electrode and the second MEA electrode proceed concurrently. The term “concurrently”, as used herein, refers in some embodiments, to the deposition processes of the first MEA electrode and the second MEA electrode, which occur in a mutual electrochemical cell and are initiated within less than about 10 seconds from each other. In further embodiments, the term “concurrently” refers to the deposition processes of the first MEA electrode and the second MEA electrode, which are initiated within less than about 5 seconds from each other. In yet further embodiments, the term “concurrently” refers to the deposition processes of the first MEA electrode and the second MEA electrode, which are initiated withing less than about 1 second from each other.

Step (ii) of the method according to the principles of the present invention can be performed in an electrochemical cell, which should be designed specifically to allow simultaneous deposition of the first MEA electrode and the second MEA electrode. According to some embodiments, the electrochemical cell comprises a first compartment and a second compartment, which are separated by the membrane, said membrane being the MEA membrane, on which the electrodes are deposited during step (ii). In further embodiments, the first precursor is disposed within the first compartment and the second precursor is disposed within the second compartment.

In some embodiments, the second compartment is formed by the membrane.

According to some embodiments, the second compartment is disposed within the first compartment. In some related embodiments, the membrane forms the walls of the second (inner) compartment.

According to some embodiments, the first compartment is disposed within the second compartment. In some related embodiments, the membrane forms the walls of the first (inner) compartment.

According to some embodiments, the first compartment and the second compartment are linearly aligned. In certain such embodiments, the membrane forms a mutual wall between the first compartment and the second compartment.

A state-of-the-art electrophoretic deposition involves the deposition of precursors from a liquid medium onto an immersed electroconductive surface (e.g., immersed electrode) by application of an electrical field. The electrophoretic motion of the precursor is determined by an electrostatic charge on their surface, which may be natural or imposed. The polarity of the electrostatic charge thereby determines which immersed electrode the precursor will migrate towards, wherein the electrodes are oppositely charged. The electrode towards which the precursor does not migrate, serves as a counter electrode. The electrical field may be the result of a constant, varying or pulsed direct current or voltage; or constant or varying balanced or unbalanced alternating current; or other simple or compound waveforms.

In the presently disclosed method, the substrate on which the precursors are deposited is electrically insulating (i.e., the membrane). In order to enable deposition on the electrically insulating membrane, it should be placed between two electrically connected electrodes. While moving towards the electrode with an opposite polarity than its own, the first precursor meets the membrane and is deposited thereon. On the other side of the membrane, the second precursor moves towards the other electrode and is deposited on the opposite surface of the membrane, upon contact therewith.

Accordingly, in order to establish electric field within the electrochemical cell, at least two electrodes having opposed polarities, should be present within the cell. The electrodes, used to establish electric field during step (ii) of the EPD method according to the principles of the present invention are termed “EPD electrodes” to distinguish them from the MEA electrodes, which are being formed on the membrane. Accordingly, in some embodiments, the electrochemical cell further includes a first EPD electrode and a second EPD electrode. In some embodiments, the first EPD electrode is disposed within the first compartment and the second electrode is disposed within the second compartment. In certain such embodiments, the first EPD electrode and the second EPD electrode are physically separated by the membrane. In further related embodiments, the membrane is in ionic contact with the first EPD electrode and the second EPD electrode during step (ii), such that the first EPD electrode and the second EPD electrode are ionically connected through the membrane. According to various embodiments, during the deposition process of step (ii), the first EPD electrode serves as a counter electrode for the second EPD electrode and the second EPD electrode serves as the counter electrode for the first EPD electrode.

The first EPD electrode can be disposed within the first compartment formed by the membrane. For example, the membrane can be in a form of a sealed sleeve comprising an opening for the insertion of the first EPD electrode. Alternatively, the second EPD electrode can be disposed within the second compartment formed by the membrane.

The EPD electrodes can be made of any suitable material, which does not react with the constituents of the suspension and withstands high voltages, such as, but not limited to, nickel, aluminum, platinum or carbon. The first EPD electrode, the second EPD electrode or both can be in a form of a film, plate, wire, mesh, or any other suitable form, as known in the art. The electrodes can be planar or cylindrical. When the electrodes are cylindrical, they can also be concentric, however, still separated by the insulating membrane.

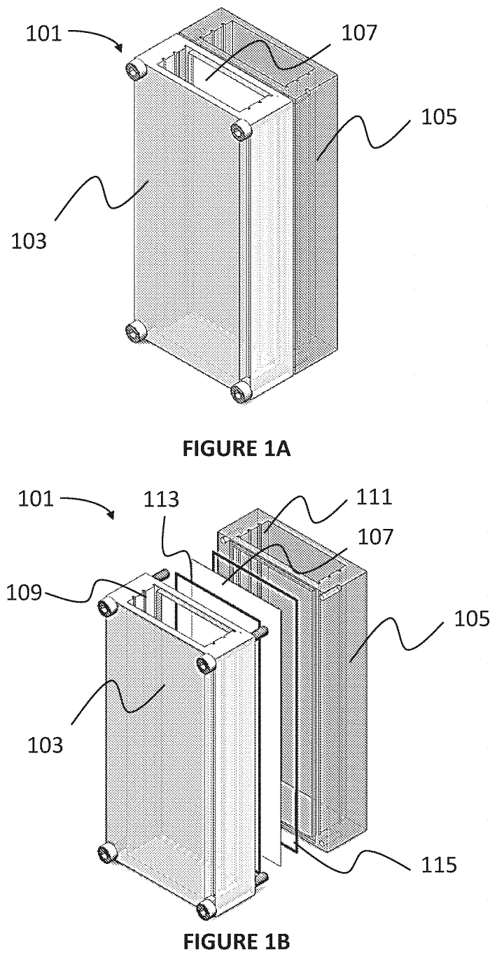

Reference is now made to FIG. 1A, which schematically represents electrochemical cell 101 for use in the method according to various embodiments of the invention. Electrochemical cell 101 includes first compartment 103 and second compartment 105. First compartment 103 and second compartment 105 are separated by electrically insulating and ion-permeable membrane 107. The first precursor can be disposed within first compartment 103 and the second precursor can be disposed within second compartment 105.

Reference is now made to FIG. 1B, which schematically represents an exploded view of electrochemical cell 101 for use in the method according to various embodiments of the invention. As mentioned above, electrochemical cell 101 includes first compartment 103 and second compartment 105. First compartment 103 and second compartment 105 are separated by electrically insulating and ion-permeable membrane 107. First compartment 103 has opening 109 for the introduction of a first EPD electrode (not shown), which can be disposed at varying distances from membrane 107. Second compartment 105 has opening 111 for the introduction of second EPD electrode (not shown), which can be disposed at varying distances from membrane 107. First compartment 103 and membrane 107 are connected and sealed with gasket 113. Second compartment 105 and membrane 107 are connected and sealed with gasket 115.

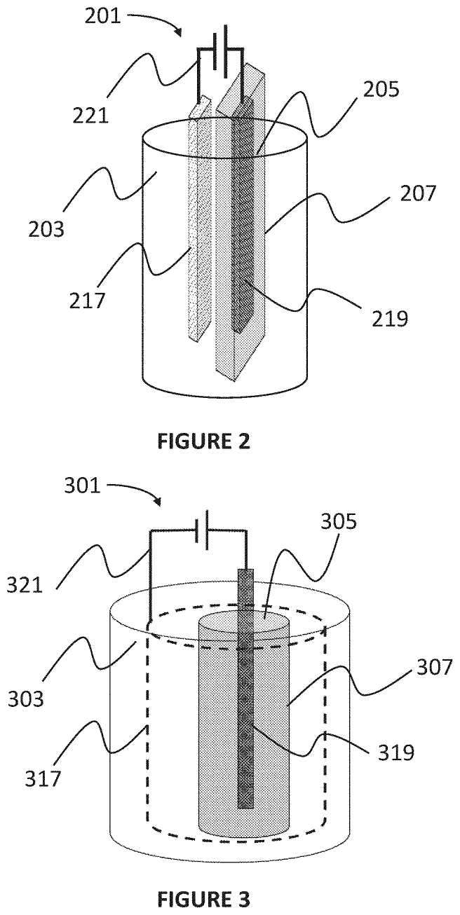

Reference is now made to FIG. 2, which schematically represents electrochemical cell 201 for use in the method according to various embodiments of the invention. Electrochemical cell 201 includes first compartment 203 and membrane 207, which forms the walls of second compartment 205. In other words, membrane 207 also functions as compartment 205. The first precursor can be disposed within first compartment 203 and the second precursor can be disposed within second compartment 205 (i.e., electrically insulating membrane 207). Membrane 207 can be, inter alia, in a form of a sleeve sealed on its bottom, or other receptacle, which physically separates the first precursor from the second precursor and/or accommodates the EPD electrode. Electrochemical cell 201 further includes first EPD electrode 217 and second EPD electrode 219, which are planar electrodes. First EPD electrode 217 and second EPD electrode 219 are connected through external electric circuit 221. First EPD electrode 217 is disposed within first compartment 203 and second electrode EPD electrode 219 is disposed within second compartment 205 (i.e., electrically insulating membrane 207). During step (ii) of the disclosed method, the first MEA electrode is deposited on the surface of membrane 207, which faces first EPD electrode 217 and the second MEA electrode is deposited on the surface of membrane 207, which is disposed between first EPD electrode 217 and second EPD electrode 219 and faces second EPD electrode 219. The first MEA electrode and the second MEA electrode are deposited on a portion of membrane 207, which is positioned between first EPD electrode 217 and second EPD electrode 219.

Reference is now made to FIG. 3, which schematically represents electrochemical cell 301 for use in the method according to various embodiments of the invention. Electrochemical cell 301 includes first compartment 303 and membrane 307, which forms the walls of second compartment 305. In other words, membrane 307 also functions as compartment 305. The first precursor can be disposed within first compartment 303 and the second precursor can be disposed within second compartment 305 (i.e., electrically insulating membrane 307). Membrane 307 can have, inter alia, a tubular form with a sealed bottom, thereby physically separating the first precursor from the second precursor. Electrochemical cell 301 further includes first EPD electrode 317 and second EPD electrode 319. First EPD electrode is a cylindrical mesh electrode and second EPD electrode is a planar electrode. First EPD electrode 317 and second EPD electrode 319 are connected through external electric circuit 321. First EPD electrode 317 is disposed within first compartment 303 and second electrode EPD electrode 319 is disposed within second compartment 305 (i.e., electrically insulating membrane 307). During step (ii) of the disclosed method, the first MEA electrode is deposited on the face of membrane 307, which faces first EPD electrode 317 and the second MEA electrode is deposited on the face of membrane 307, which faces second EPD electrode 319.

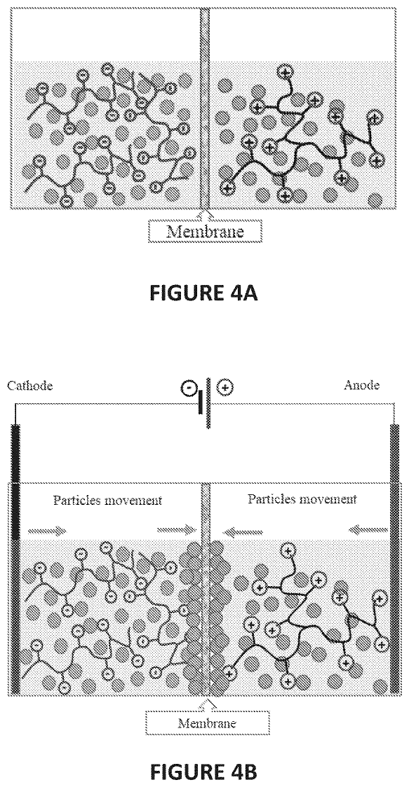

Reference is now made to FIG. 4A, which schematically represents an electrochemical cell for use in the method according to various embodiments of the invention, before step (ii). The electrochemical cell includes a first compartment and a second compartment. The first compartment contains a first suspension comprising a first precursor suspended within a liquid electrolyte. The first precursor comprises a first electrode active material, which is neutral, and a positively charged charging agent. The second compartment contains a second suspension comprising a second precursor suspended within a liquid electrolyte. The second precursor comprises a second electrode active material, which is neutral, and a negatively charged charging agent. The first compartment and the second compartment are separated by an electrically insulating and ion-permeable membrane. The membrane is further impermeable to the first precursor and the second precursor.

Reference is now made to FIG. 4B, which schematically represents an electrochemical cell for use in the method according to various embodiments of the invention, during step (ii). The electrochemical cell further includes a first EPD electrode, being an anode, which is disposed within the first compartment and a second EPD electrode, being a cathode, which is disposed within the second compartment. The EPD electrodes are connected through an external electric circuit. When voltage is applied between the anode and the cathode, the first precursor particles move towards the cathode (and the membrane) and the second precursor particles move towards the anode (and the membrane). The direction of the precursors' movement is indicated by arrows). When the first precursor particles meet the membrane and as they cannot penetrate it, the first precursor particles are deposited on the side of the membrane, which faces the anode, thereby forming the first MEA electrode. Similarly, when the second precursor particles meet the membrane and as they cannot penetrate it, the second precursor particles are deposited on the side of the membrane, which faces the cathode, thereby forming the second MEA electrode.

When the first MEA electrode and the second MEA electrode are being deposited—they should also be in ionic contact, as long as the EPD process continues. In addition to adjusting the membrane ionic conductivity parameters and electrochemical cell configuration, the voltage applied between the first EPD electrode and the second EPD electrode during the EPD process, can also be selected to maintain the desired ionic contact. The applied voltage can, affect, inter alia, the rate of the deposition of the first MEA electrode and the second MEA electrode, as well as, thickness, morphology and/or density thereof. All these parameters can, in turn, affect ionic contact between the first precursor and the second precursor and between the first MEA electrode and the second MEA electrode.

According to some embodiments, the EPD process in step (ii) is performed at a constant voltage. According to some embodiments, the EPD process in step (ii) is performed at a constant current.

The EPD process in step (ii) can be performed at a voltage bias of from about 20V to above 500V. In particular embodiments, the EPD process is performed at a voltage bias of from about 30V to about 150V, from about 40V to about 125V, or from about 50V to about 100V. Each possibility represents a separate embodiment of the invention. In one embodiment, the EPD process is performed at a voltage bias of about 50V. In another embodiment, the EPD process is performed at a voltage bias of about 100V. In particular embodiments, in the suspensions, based on low-dielectric-constant viscous solvents, the EPD process is performed at a voltage bias of above 500V.

The EPD process in step (ii) can be performed at a current density of from about 1 μA/cm² to about 10 mA/cm². In some embodiments, the EPD process is performed at a current density of from about 10 μA/cm² to about 1 mA/cm².

According to some embodiments, the EPD process in step (ii) is performed at voltage, which is linearly varied. In other embodiments, the EPD process is performed at a pulsed voltage.

The EPD can alternatively be performed at a varying balanced or unbalanced alternating current having any suitable waveform, as known in the art.

In some embodiments, duration of the EPD process in step (ii) is from about 5 sec to about 30 minutes. In further embodiments, the duration of the EPD process is from about 10 sec to about 20 minutes. In yet further embodiments, the duration of the EPD process is from about 20 sec to about 10 minutes. In still further embodiments, the duration of the EPD process is from about 30 sec to about 5 minutes. In yet further embodiments, the duration of the EPD process is from about 30 sec to about 2 minutes. In one embodiment, the duration of the EPD process is about 30 sec. In one embodiment, the duration of the EPD process is about 5 minutes.

Another important parameter, which affects the EPD process efficiency and properties of the formed MEA electrodes, is the distance between the first EPD electrode and the membrane and the distance between the second EPD electrode and the membrane. According to some embodiments, the distance between the first EPD electrode and the membrane ranges from about 10 μm to about 30 mm. According to further embodiments, the distance between the first EPD electrode and the membrane ranges from about 100 μm to about 20 mm. According to further embodiments, the distance between the first EPD electrode and the membrane ranges from about 1 mm to about 10 mm. According to some embodiments, the distance between the second EPD electrode and the membrane ranges from about 10 μm to about 30 mm. According to further embodiments, the distance between the second EPD electrode and the membrane ranges from about 100 μm to about 20 mm. According to further embodiments, the distance between the second EPD electrode and the membrane ranges from about 1 mm to about 10 mm. The first and the second EPD electrodes can be disposed at a similar or different distance from the membrane.

Step (ii) can be repeated until the desired thickness or loading are obtained. In some embodiments, step (ii) is repeated at least once. In some embodiments, step (ii) is repeated at least twice. In some embodiments, step (ii) is repeated at least 3, 4, 5, or 10 times. When repeating step (ii), a new portion of the first precursor and of the second precursor can be added to the electrochemical cell.

According to some embodiments, the method further comprises step (iii) comprising drying the obtained MEA. The MEA can be dried at a temperature ranging from about 20° C. to about 300° C. In some exemplary embodiments, the MEA is dried at a temperature of about 50° C. Preferably, the drying is performed under vacuum. The drying can be performed for from about 2 hours to about 72 hours. In some embodiments, the drying is performed for from about 12 hours to about 48 hours.

In another aspect, there is provided an electrochemical cell for use in a method for concurrent electrophoretic deposition of an MEA according to the various embodiments of the present invention, wherein the electrochemical cell comprises the electrically insulating ion-permeable membrane having two opposed surfaces comprising a first surface and a second surface. The electrochemical cell can have any configuration, which allows physical separation between the first precursor and the second precursor and ionic connection therebetween during step (ii). In some currently preferred embodiments, the membrane provides said physical separation and ionic contact between the first precursor and the second precursor within the electrochemical cell.

The electrochemical cell can further include the EPD electrodes, as described hereinabove. According to some embodiments, the electrochemical cell comprises a first compartment, which is configured to hold a suspension comprising the first precursor and/or the first EPD electrode, and a second compartment, which is configured to hold a suspension comprising the second precursor and/or second first EPD electrode. In some related embodiments, the membrane separates the first compartment from the second compartment.

In some embodiments, the second compartment is formed by the membrane.

The electrochemical cell can further include one or more gaskets to prevent or diminish leakage from the first compartment to the second compartment and vice versa, thereby affording for or improving the physical separation between the first and the second precursors.

The electrochemical cell can have any structure, including, inter alia, the ones described in detail in FIGS. 1-4B.

In yet another aspect, there is provided a membrane-electrode assembly prepared by the method according to the principles of the present invention. The membrane can be a porous separator or an ion exchange membrane, as detailed hereinabove. In some embodiments, the first MEA electrode comprises the first electrode active material and the second MEA electrode comprises the second electrode active material. The first MEA electrode, the second MEA electrode or both can further comprise at least one of the charging agent, the conducting agent, and the binder. Preferably, the first MEA electrode and the second MEA electrode are solid state electrodes.

According to some embodiments, the first MEA electrode is essentially free of the second electrode active material According to some embodiments, the second MEA electrode is essentially free of the first electrode active material. The term “essentially free”, as used herein, refers to a relative loading of less than about 1% as compared to the loading of the electrode active material, which is deliberately deposited on said side of the membrane. The term “loading”, as used herein with respect to the MEA electrode, refers to the weight of the electrode active material divided by the geometric area of the first or the second surface of the membrane.

The first MEA electrode, the second MEA electrode or both can have a thickness ranging from about 0.05 μm to about 100 μm.

In some embodiments, the MEA has a thickness ranging from about 5 μm to about 1200 μm. The thickness of the MEA is defined as the distance between the external surface of the first MEA electrode and the external surface of the second MEA electrode.

The MEA prepared by the method according to the principles of the present invention can be used in an electrochemical device, such as, for example, an energy storage device, water deionization device, optical device, or a sensor. Non-limiting examples of suitable energy storage devices include a Li-ion battery, fuel cell, flow cell, supercapacitor, and photoelectrochemical cell. Non-limiting examples of a suitable water deionization device include capacitive deionization (CDI) device, and deionization fuel cell. One non-limiting example of a suitable optical device is electrochromic device. The sensors can include electrochemical or biochemical sensors.

According to another aspect, there is provided an electrochemical device comprising the MEA prepared by the method according to the principles of the present invention. Said electrochemical device can be selected from a Li-ion battery, fuel cell, flow cell, supercapacitor, photoelectrochemical cell, capacitive deionization (CDI) device, deionization fuel cell, electrochromic device, and sensor. In certain embodiments, the electrochemical device is a Li-ion battery.

In some embodiments, said electrochemical device is a wearable device. In additional embodiments, said electrochemical device is a flexible device. In additional embodiments, said electrochemical device is a flexible device.

The electrochemical device can further contain an electrolyte, which can be aqueous or organic. In some embodiments, the electrochemical device further comprises a catholyte and/or anolyte. The catholyte, anolyte or both can be aqueous or organic. In some embodiments, the electrolyte fills the pores of the membrane. The electrochemical device can further include current collectors, gaskets, bipolar plates, bus plates with electrical connections, and/or end plates.

As used herein and in the appended claims the singular forms “a”, “an,” and “the” include plural references unless the content clearly dictates otherwise. Thus, for example, reference to “a particle” includes a plurality of such particles and equivalents thereof known to those skilled in the art, and so forth. It should be noted that the term “and” or the term “or” is generally employed in its sense including “and/or” unless the content clearly dictates otherwise. The term “plurality” is meant to encompass two or more.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed methods.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1—Preparation of the Suspension and Deposition Process Parameters

LiFePO₄ (LFP, Life Power P2, Clariant) and Li₄Ti₅O₁₂ (LTO, Life Power C-T2, Sud-Chemie Clariant) powders were used as active electrode materials. Super P C45 and C65 carbon (Timcal)—as conducting additives. Polyelectrolytes Poly(acrylic acid) (PAA) and Polyethyleneimine, branched PEI (25,000 MW, Sigma-Aldrich)—as the binders and charging agents. Commercial Celgard 2325 was used as a membrane.

For cathodic EPD, the PEI (0.1%) was used as a charging agent, and 2% PAA as a binder. For anodic EPD, the PAA (3% w/w) functions both as a charging agent and as a binder. For both anodic and cathodic EPD the active-material content (LFP or LTO) was 85%, carbon-additive content, 10% (w/w) and solid loading was 3-4 mg/ml solvent. The suspension also included 0.25% (v/v) acetylacetone (Sigma-Aldrich).

For DC EPD, a Keithley SourceMeter model 2400 interfaced with LabTracer software and a PC was used to control the EPD process and to monitor the current and voltage profiles.

The constant voltage of 50 or 100V was applied to nickel or aluminum electrodes, in front of which the Celgard membrane was placed. The deposition duration was from 30 to 300 seconds.

The deposited three-layer thin-film LFP/Celgard/LTO samples were dried under vacuum at 50° C. for 24 hours. All subsequent handling of these materials took place under an argon atmosphere in the MBraun glove box containing less than 0.1 ppm water.

### Example 2—Cell Assembly and Characterization

The three-layer membrane-electrode assembly (MEA) was soaked in commercial electrolyte (1M LiPF₆ in 1:1 EC:DEC:2% VC, Solvionics) and sealed in electrochemical coin cells (type 2032). The cells were cycled at room temperature in a Biologic VMP3 and BCS 805 battery-test system.

A JSM-6300 scanning microscope (Jeol Co.) equipped with a Link elemental analyzer and a silicon detector, was used for the study of the surface morphology of the electrodes.

TOF SIMS tests were performed with the use of a TRIFT II (Physical Electronics Inc. USA) under the following operating conditions: primary ions (indium), DC sputtering rate 0.035 nm·min⁻¹ based on SiO₂ reference. Modulated high-resolution tests of the composite films were conducted with the use of high-sensitivity thermogravimetric analyzer Q5000 TGA-IR (TA Instruments), which operates from ambient temperature to 1000° C. The weight of the samples was 3-5 mg.

### Example 3—Individual Deposition of Each One of the Electrodes on the Membrane

First, deposition of each one of the electrodes on a conductive substrate (nickel) was tested in order to compare the EPD efficiency on electrically conductive and insulating substrates. Then, deposition of each one of the electrodes on the membrane was tested to enable comparison of the concurrent EPD process with the two individual deposition processes. The suspensions and the membrane used were as described in Example 1.

Celgard 2325 membrane is a tri-layer polypropylene-polyethylene-polypropylene 25 μm-thick film with a porosity of 39% and pore size not exceeding 28 nm. This membrane, in addition, is known to have good wettability by acetone and typical nonaqueous electrolytes used in lithium-ion batteries.

In most of the tests, the LFP was deposited cathodically and the LTO anodically on the membrane, which was placed in front of the electrode, both at 100V. The deposition duration was from 30 to 300 seconds.

It is well established that the surface charge of particles dispersed in suspension can be brought about by the adsorption of ionic species and/or polyelectrolytes. The negative charge of PAA in the solutions at pH >4 is attributed to the deprotonated COOH groups of the macromolecules. The positive charge of PEI, the second polyelectrolyte used by us in the acetone-based suspension, is induced by the acetylacetone additive via a keto-enol reaction. It has been recently found that linear PEI, when adsorbed on the surface, creates strong electrostatic repulsion between the particles, which in some cases even eliminates the formation of deposits. Branched PEI facilitates stabilization of the suspension, presumably via the electrosteric mechanism and promotes the formation of cathodic coatings.

It has been shown that adhesion of the LFP-PEI films to Celgard 2325 was inferior to the films deposited from the suspension containing two polymers, PEI and PAA. It is important to emphasize that simply by replacing the charging agents in the appropriate suspensions, the LFP can be electrophoretically deposited on the anode and the LTO on the cathode. Moreover, it was found that LFP particles dispersed in acetone solvent with acetylacetone alone undergo anodic deposition, while the ξ-potential induced by this additive to the LTO particles is insufficient to enable their EPD. Increased concentration of PAA (3% w/w) facilitates the migration of both types of particles towards the anode, while the combination of PEI (1% w/w) and PAA (2% w/w)—towards the cathode.

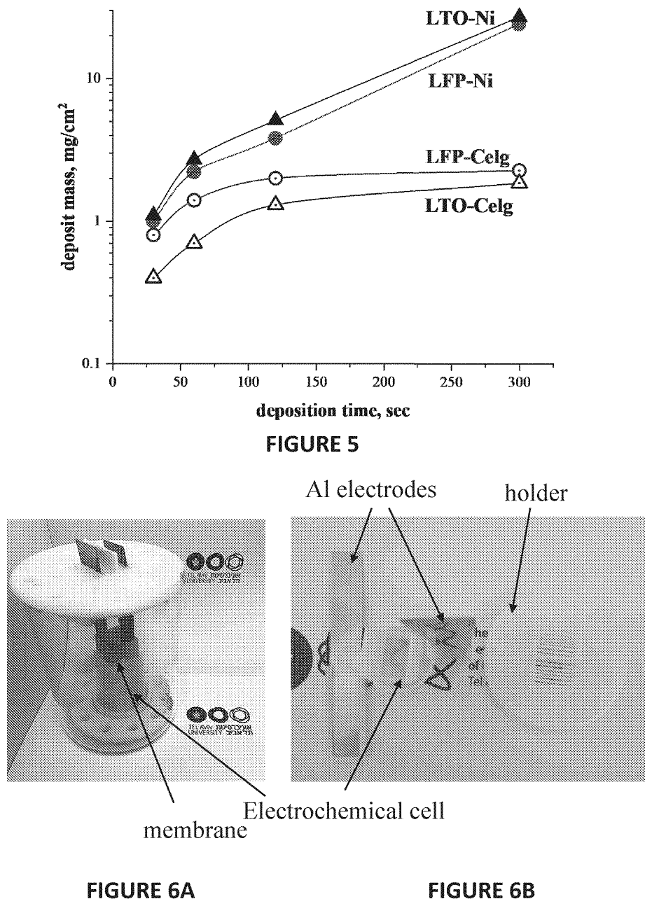

The mass of the deposited materials was found to increase with deposition time, leading to the formation of films of different thicknesses. FIG. 5 shows that the electrophoretic deposition of both LFP and LTO particles occurs more quickly on a nickel substrate than on Celgard membrane. While the cathodic yield on nickel is higher than the anodic for both materials, the inverse dependence is seen for EPD on the membrane, namely, the cathodic process is much slower than the anodic. Moreover, it has been found that at constant deposition voltage, the current drops dramatically, when a nanoporous polymer membrane is inserted perpendicular to the electric field between the electrodes. Without wishing to being bound by theory or mechanism of action, it is suggested that while there is a continuous path of protons through the micropores, their partial blockage by the deposit, followed by the increased resistance of the polymer partition, impedes the deposition rate.

### Example 4—Concurrent Deposition of the MEA Electrodes

Two different electrochemical cells were tested for the simultaneous deposition of LFP and LTO on the opposite sides of the membrane.

The first electrochemical cell for simultaneous electrophoretic deposition on membrane included a positive aluminum working electrode, which was placed inside the heat-sealed sleeve prepared from Celgard 2325. The negative aluminum counter electrode was placed outside the Celgard sleeve within the electrochemical cell. The photo of this setup is shown in FIG. 6A. The deposition bath and the holder for the electrodes were 3D-printed by the fused-filament-fabrication method. The holder, which has several gaps, enables control of the distance between the membrane and the electrodes and the suspension volumes in the electrochemical cell (FIG. 6B).

The first electrochemical cell for simultaneous electrophoretic deposition on membrane, is shown in FIGS. 1A and 1B. The acetone-based suspensions, comprising negatively charged LTO particles and positively charged LFP particles, were introduced to the different compartments of the cell, as schematically shown in FIG. 4A. As described by Sarkar and Nicholson (M. Ordung, J. Lehmann, G. Ziegler, Fabrication of fibre reinforced green bodies by electrophoretic deposition of silicon powder from aqueous suspensions, J. Mater. Sci. 39 (2004) 889-894), in order to achieve deposition on a porous membrane, an ionic path must be maintained; in other words, there must be sufficient wetting of the membrane by the electrolyte solvent. In the case of suspensions based on acetone and ethanol, a 2325 Celgard membrane achieves sufficient wetting. Upon application of external DC voltage to the cell, the concurrent EPD of oppositely charged particles starts immediately. Positively charged LFP particles migrate towards the cathode, while negatively charged LTO particles simultaneously migrate towards the anode. Neither LFP (˜200 nm PSD) nor LTO (˜150 nm PSD) can penetrate the membrane and, as a result, they coat the opposite sides of the membrane. A pictorial illustration of this process is shown in FIG. 4B. It was shown that at low deposition times (up to 120 sec) the deposition rate of concurrently on-membrane-deposited materials is close to that of separately deposited LFP and LTO composites. It can therefore be concluded that efficiency of the concurrent EPD process is similar to the efficiency of the individual deposition processes, while being at least twice faster (since the two electrodes are being formed at the same time).

### Example 5—Physical and Chemical Characterization of the MEA Electrodes Deposited by the Concurrent Deposition Method

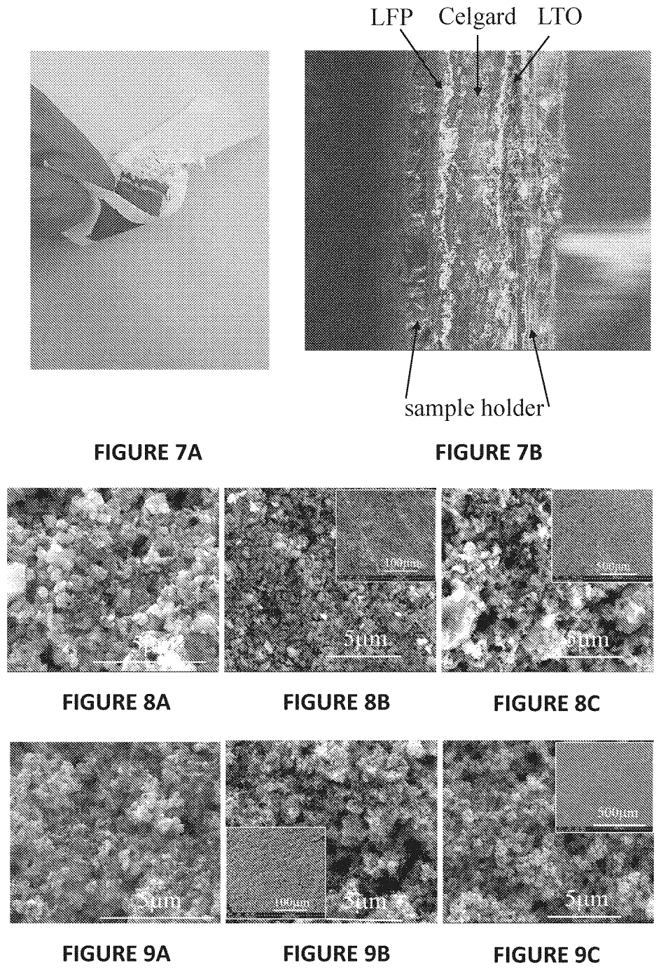

An optical photograph (FIG. 7A) and cross-sectional Environmental Scanning Electron Microscopy (ESEM) image (FIG. 7B) show the three-layer LFP/Celgard2335/LTO membrane electrode assembly prepared by EPD. It is worth mentioning, that no penetration of LFP and LTO particles via the membrane was detected at simultaneous EPD process.

The ESEM micrographs of the LFP and LTO electrodes are compared in FIGS. 8A-8C and 9A-9C, respectively, wherein said electrodes were obtained by individual and concurrent EPD processes. At low magnification, the morphology of all the samples appears homogeneous (as can be seen from the insets). High-resolution ESEM enables the observation of mostly separated LFP and LTO particles in the deposits. A network of carbon, filling the gaps between LFP and LTO particles, can be easily distinguished at high-magnification. While solitary aggregates are detected in the cathodically deposited LFP and LTO films, the separation of the particles in anodic coatings of both materials is much better. It can be assumed that the simultaneous deposition of both materials on the opposite sides of Celgard membrane does not influence the morphology of the films as compared to individually deposited electrodes.

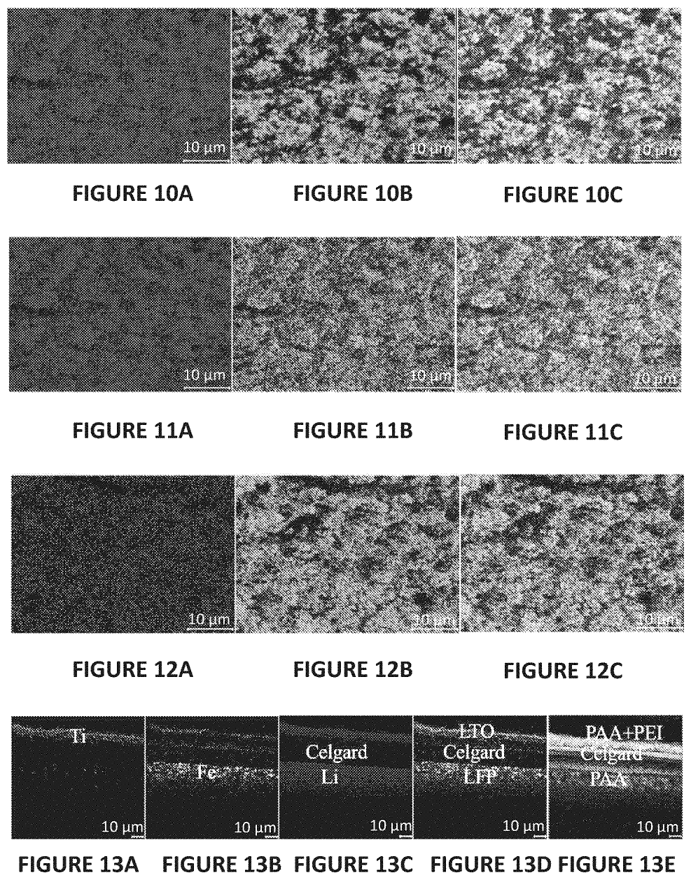

Time-of-Flight Secondary Ion Mass Spectrometry (TOF-SIMS) provides elemental, chemical-state and molecular information from surfaces of solid materials. With the goal of determining the spatial distribution of the active-material particles and polyelectrolytes, the TOF-SIMS tests (FIGS. 10A-10C, 11A-11C, 12A-12C, and 13A-13E) were carried out both in the negative-ion and positive-ion modes. To obtain higher ionic yield and better resolution, positive-ion images of the electrodes were analyzed after very brief Cs⁺ sputtering (cleaning of the surface). Species of Li, Fe (from LiFePO₄), C, CHN and CHO (fragments from PEI and PAA) were detected in the positive-ion mass spectra acquired from the surface of the LFP electrode prepared by simultaneous EPD on one side of the membrane. The individual-ion and total-ion images (10 μm×10 μm) were normalized in such a way that the lowest measured intensity corresponds to the darkest color and the highest intensity to the brightest one. Ion images (FIGS. 10A-10C) show that the cathode has a porous structure, with polymer, which not only fills the pores between single particles and aggregates of LFP, but also coats their surface. FIGS. 11A-11C show good intermixing of both polyelectrolytes, PEI and PAA. The spatial distribution of lithium titanate and polyacrylic acid fragments in the anodically deposited LTO composite on the second side of the membrane resembles the ESM morphology of the sample (FIGS. 12A-12C) demonstrating porous morphology, as well. Cross-sectional TOFSIMS images FIGS. 13A-13E support the optical and ESEM observations of the simultaneous deposition of LFP and LTO composite layers on the opposite sides of Celgard membrane and the absence of their intermixing. When imaging Fe in the LFP layer, there is some weak signal which is seen also on LTO side, which is due to the fact that there is a mass peak of C3H6N existing on Ti side, and it has a close mass to Fe, which is not real signal of the LFP. This effect is almost eliminated by narrowing the mass peaks for imaging.

### Example 6—Electrochemical Characterization of the MEA Electrodes Deposited by the Concurrent Deposition Method

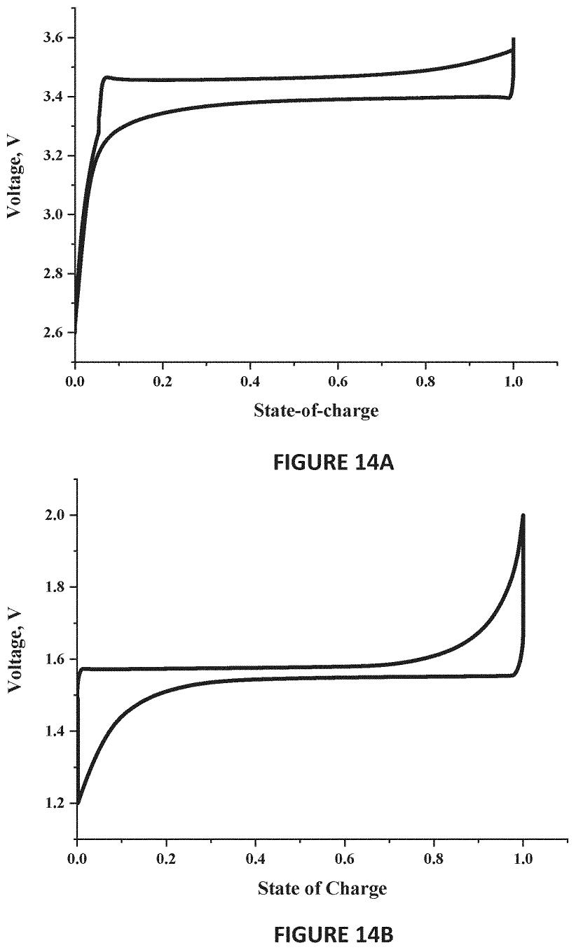

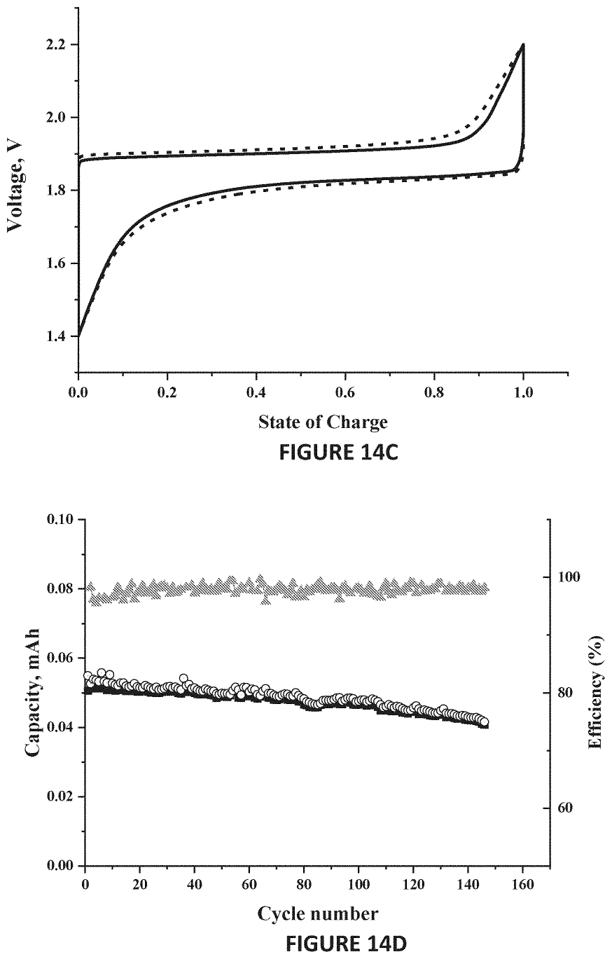

The results of electrochemical testing of half- and full-coin-cells (LFP/Li, LTO/Li and LFP/LTO) with the electrodes deposited electrophoretically on Celgard, are presented in FIGS. 14A-14D. The profiles of voltage vs. state-of-charge of lithium cells, containing LFP and LTO electrodes deposited on the membrane, are found to be similar to the cells with EPD electrodes deposited on nickel and to the voltage profiles of commercial batteries (FIGS. 14A-14C). The deposition of electrodes for the formation of MEA was carried out at 100V and 30 sec. The LFP/Celgard/LTO MEA cells have been cycled at different C-rates with 125-140 mAh/g capacity, which is close to that of the theoretical LFP value. This capacity can be further increased by increasing the electrode thicknesses.

### Example 7—Electrophoretic Deposition of Graphite-Based Anode on Glass Microfiber Membrane

Electrophoretic deposition of graphite-based anode on GE Whatman glass microfiber 1825-150 membrane was carried out from water-based suspension. The mean pore size of the Whatman glass microfiber membrane is about 0.3 μm. The suspension contained: 250 mg Graphite (micron-sized particles), 100 μl Triton-X100, 0.5 ml 0.5% PAA in H₂O, and 20 ml H₂O. In order to improve homogeneity of the suspension, it underwent ultrasonic agitation for 3 minutes. The mean particle size of colloidal graphite within the suspension was 0.5-1.5 μm. For the EPD of graphite-based anode the setup for simultaneous deposition with the membrane in the middle and two nickel electrodes at 1.5 cm from each other was used (as shown in FIG. 1B). The electrophoretic deposition was carried out at 10V for 1 min.

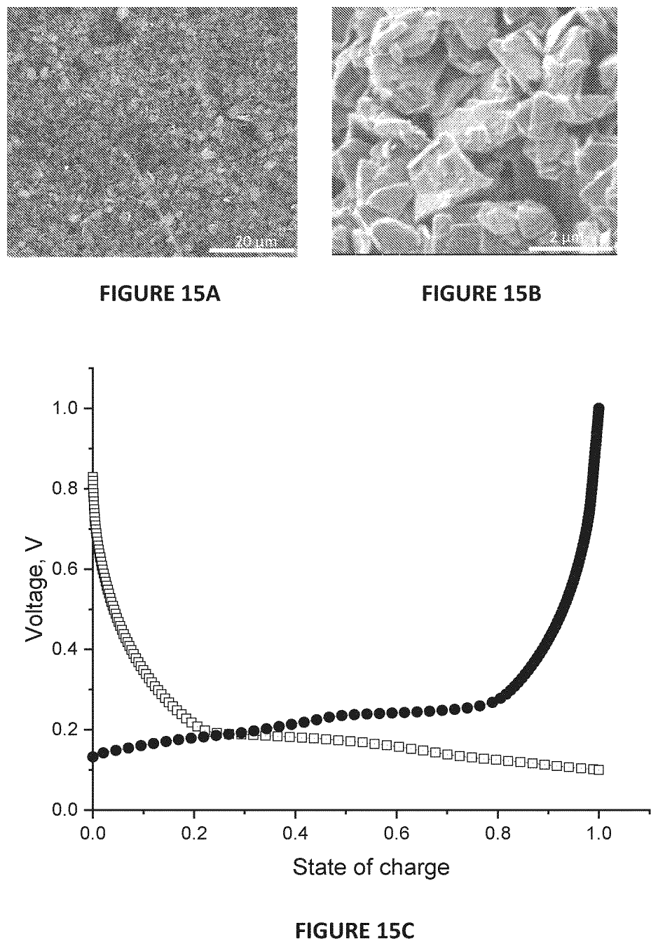

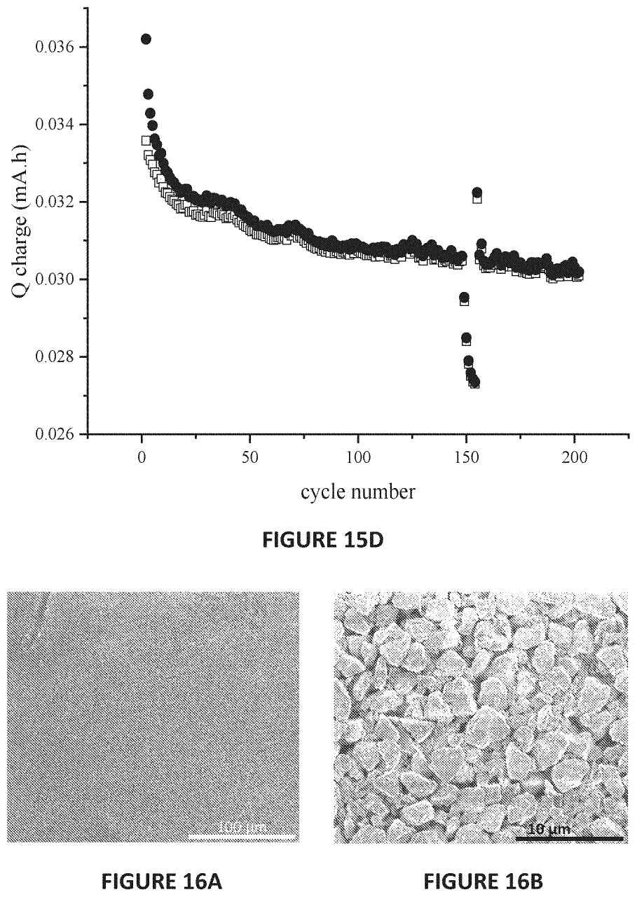

ESEM images at different magnifications (FIGS. 15A and 15B) show Whatman membrane, one side of which is completely coated by graphite flakes. The second part is completely clean, which indicates that graphite particles do not penetrate the membrane during EPD. This phenomenon can be attributed to the difference in the mean particle size of colloidal graphite and the mean pore size of the membrane, wherein the mean particle size is at least about 60% higher than the mean pore size.

The electrochemical cell comprising lithium anode, graphite-on-Whatman membrane and LiPF₆:EC:DEC electrolyte was assembled and tested. FIG. 15C shows charge/discharge curves of the cell, which are similar to the typical intercalation/deintercalation of lithium in Li/cast Graphite cells (FIG. 15C). The cell run for more than 200 reversible cycles and close to 100% coulombic efficiency (FIG. 15D).

### Example 8—Electrophoretic Deposition of Silicon-Based Anode on Glass Microfiber Membrane

Electrophoretic deposition of a silicon-based anode on GE Whatman glass microfiber 1825-150 membrane was carried out from water-based suspension. The mean pore size of the Whatman glass microfiber membrane is about 0.3 μm. The suspension for the anode deposition contained: 250 mg silicon (micron-sized particles), 0.5 ml 0.5% PAA in H₂O, and 20 ml H₂O. The mean particle size of colloidal silicon within the suspension was 1-3 μm. The same setup was used for the EPD, as in Example 7. The electrophoretic deposition was carried out at 10V for 1 min. ESEM images at different modifications (FIGS. 16A and 16B) show dense deposit on one side of Whatman membrane. Micron-sized Si particles do not penetrate the membrane during EPD. This phenomenon can be attributed to the difference in the mean particle size of colloidal silicon and the mean pore size of the membrane, wherein the mean particle size is at least about three-fold higher than the mean pore size.

### Example 9—Electrophoretic Deposition of Lithium Manganese Oxide-Based Anode on Glass Microfiber Membrane

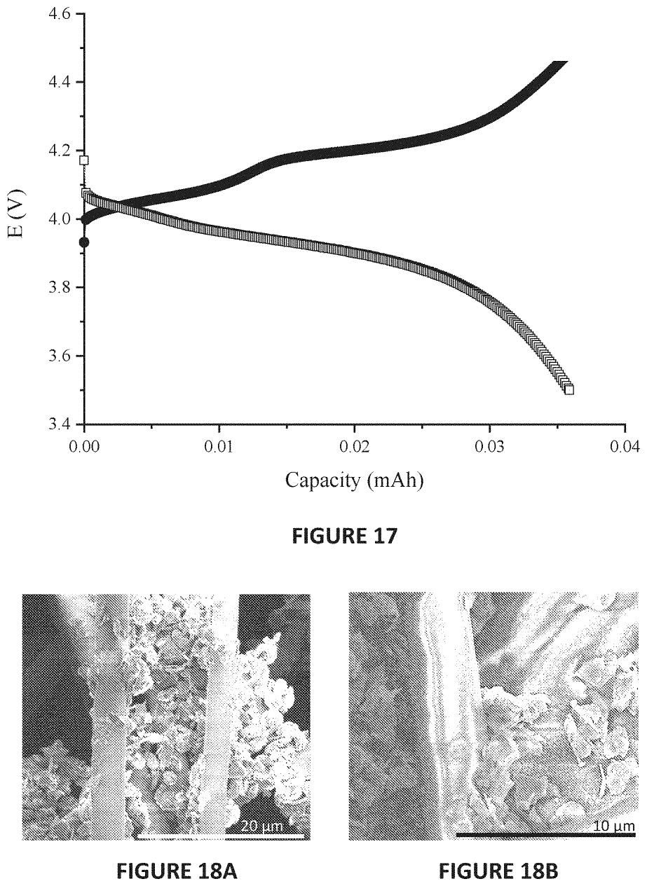

Electrophoretic deposition of a LiMn₂O₄-based anode on GE Whatman glass microfiber 1825-150 membrane was carried out from water-based suspension. The mean pore size of the Whatman glass microfiber membrane is about 0.3 μm. The suspension contained: 250 mg. LiMn₂O₄ (micron-sized particles), 50 mg carbon black, 0.5 ml 0.5% PAA in H₂O, and 20 ml H₂O. In order to improve homogeneity and stability of the suspension, ultrasonic agitation for 3 min was performed. The mean particle size of colloidal LiMn₂O₄ within the suspension was 1-3 μm. The same setup was used for the EPD, as in Example 7. The electrophoretic deposition was carried out at 10V for 1 min. The deposited electrode was assembled in the coin-cell setup with typical Celgard separator and electrolyte and electrochemically tested. FIG. 17 shows charge/discharge profile of the cell with an average operating voltage of 3.8V.

### Example 10 (Comparative)—Electrophoretic Deposition of Graphite-Based Anode on Glass Microfiber Membrane with Larger Mean Pore Size

The same suspension as in Example 7 and the same EPD parameters were used for the deposition of graphite-based anode on Electrolock glass fiber membrane. ESEM images at different modifications (FIGS. 18A and 18B) show the glass fiber membrane, coated by graphite flakes. According to the ESEM images, the mean pore size of the glass fiber membrane is 10-20 μm. Because of the relatively large pores between the fibers as compared to the mean particle size of the colloidal graphite (10-20 μm vs 0.5-1.5 μm, respectively) the deposit was found on both sides of the membrane (FIG. 18B), which emphasizes the need for the careful choice of the mean particle size of the precursors' colloidal particles and the mean pore size of the membrane, such that the first precursor is physically separated from the second precursor by the membrane. Preferably, the colloidal particles should have a mean particle size, which is larger than the mean pore size of the membrane.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1.-39. (canceled)

40. A method for concurrent electrophoretic deposition (EPD) of a membrane-electrode assembly (MEA) comprising a first MEA electrode and a second MEA electrode, comprising:
i. providing an electrically insulating ion-permeable membrane having two opposed surfaces comprising a first surface and a second surface; and
ii. electrophoretically depositing the first MEA electrode from a suspension comprising a first precursor on the first surface of the membrane and electrophoretically depositing the second MEA electrode from a second suspension comprising a second precursor on the second surface of the membrane, wherein the first precursor is physically separated from and ionically connected to the second precursor by said membrane.

41. The method according to claim 40, wherein the first MEA electrode and the second MEA electrode are deposited concurrently.

42. The method according to claim 40, wherein the membrane is a porous separator selected from the group consisting of a polymer separator, ceramic separator, zeolite separator, glass separator, and combinations thereof; or wherein the membrane is an ion exchange membrane selected from the group consisting of a non-alkaline anion exchange membrane, alkaline anion exchange membrane (AAEM), hydroxide-exchange membrane (HEM), anion-exchange ionomer membrane (AEI), non-acidic cation exchange membrane, proton-exchange membrane (PEM), cation-exchange ionomer membrane, and combinations thereof.

43. The method according to claim 42, wherein the porous separator has a mean pore size ranging from about 0.01 to about 10 μm; or wherein the polymer separator comprises a polymer selected from the group consisting of polyethylene (PE), polypropylene (PP), poly (tetrafluoroethylene) (PTFE), polyvinyl chloride (PVC), polyvinylidene difluoride (PVDF), polymethyl methacrylate, and combinations thereof.

44. The method according to claim 40, wherein the first precursor, the second precursor or both are in a form of colloidal particles suspended in a liquid electrolyte, wherein the colloidal particles of the first precursor and of the second precursor have opposite polarities.

45. The method according to claim 44, wherein the colloidal particles have a mean particle size, which is at least about 5% larger than the mean pore size of the membrane; or
wherein the liquid electrolyte comprises a solvent selected from the group consisting of acetone, acetyl acetone, water, benzene, toluene, methanol, ethanol, isopropyl alcohol, 1,4-butanediol, dichloromethane, glacial acetic acid, and combinations thereof; or
wherein the liquid electrolyte further comprises at least one of sulfuric acid, hydrochloric acid, perchloric acid, trifluoromethanesulfonic acid, nitric acid, benzoic acid, iodine, sodium hydroxide, potassium hydroxide, ammonium hydroxide, and tetramethylammonium hydroxide (TMAH).

46. The method according to claim 40, wherein the first precursor comprises a first electrode active material and the second precursor comprises a second electrode active material.

47. The method according to claim 46, wherein the first electrode active material comprises a lithiated active material, selected from the group consisting of LiFePO₄, LiMnPO₄, LiCoPO₄, LiCoO₂, LiNiO₂, Li(Al,Ni,Mn)O₂, LiMnO₂, LiMn₂O₄, Li₂MnO₃, LiNiMnCoO, and combinations thereof; or
wherein the second electrode active material is a Li-battery anode active material, selected from the group consisting of lithium titanate (Li₄Ti₅O₁₂), graphitic carbon, disordered carbon, tin oxide, indium tin oxide, vanadium oxide, manganese oxide, chromium oxide, iron oxide, nickel oxide, cobalt oxide, lithium-silicon, tin-cobalt, silicon, aluminum, zinc, tin, silver, antimony, bismuth, and combinations thereof; or wherein the first electrode active material, the second active electrode material or both comprise a fuel cell or flow cell electrode active material, selected from the group consisting of carbon, metal, metal carbide, metal nitride, metal oxide, transition metal chalcogenide, transition metal macrocyclic compound, conducting polymer, and combinations thereof.

48. The method according to claim 47, wherein the metal is selected from the group consisting of Pt, Pd, Ru, Au, Ag, Ir, Rh, Re, Cu, Ce, Cd, Zn, Fe, Mo, Ni, Co, Cr, Al, and alloys, and combinations thereof.

49. The method according to claim 46, wherein the first electrode active material, the second active electrode material or both comprise a supercapacitor electrode active material selected from the group consisting of carbon, metal, metal phosphate, metal nitride, metal oxide, transition metal chalcogenide, conducting polymer, and combinations thereof.

50. The method according to claim 49, wherein said carbon is provided in a form of graphitic carbon, activated carbon, carbon black, carbon beads, carbon fibers, carbon microfibers, carbon cloth, carbon paper, fullerenic carbons, carbon nanotubes (CNTs), graphene sheets or aggregates of graphene sheets, and materials comprising fullerenic fragments; or
wherein the metal oxide is selected from the group consisting of MnₙOₓ, TiOₓ, NiOₓ, CoOₓ, SnOₓ, and combinations thereof, wherein x ranges from 1.5 to 3 and/or wherein the transition metal chalcogenide is selected from the group consisting of FeS_{y}, MoS_{y}, NiS_{y}, CoS_{y}, MnS_{y}, TiS_{y}, SnS_{y} and combinations thereof, wherein y ranges from 1.8 to 2.2 and n ranges from 1 to 2.

51. The method according to claim 40, wherein the first precursor, the second precursor or both further comprise a charging agent,
wherein the charging agent is selected from the group consisting of PAA, PEI, Nafion, polydiallyldimethylammonium (PDDA), and polystyrene sulfonic acid (PSS); or
wherein the first precursor, the second precursor or both further comprises a binder selected from the group consisting of PAA, PVDF, polyacrylonitrile (PAN), poly-methyl methacrylate (PMMA), carboxymethyl cellulose (CMC), and combinations thereof; or
wherein the first precursor, the second precursor or both further comprise a conducting agent selected from the group consisting of carbon black, graphite, meso-porous micro-beads (MCMB), single- and multiwall carbon nanotubes, metal nanoparticles, and combinations thereof.

52. The method according to claim 40, wherein the first suspension comprises the first precursor comprising LiFePO₄, branched PEI, PAA, and carbon black; or wherein the second suspension comprises the second precursor comprising Li₄Ti₅O₁, PAA, and carbon black.

53. The method according to claim 52, wherein the first precursor comprises:
about 70-95% (w/w) LiFePO₄;
about 0.01-1% (w/w) branched PEI;
about 0.5-5% (w/w) PAA; and
about 5-20% carbon black; or
wherein the second precursor comprises:
about 70-95% (w/w) Li₄Ti₅O₁₂,
about 1-7% (w/w) PAA; and
about 5-20% carbon black.

54. The method according to claim 52, wherein the first suspension and the second suspension further comprise acetone and acetylacetone as the liquid electrolyte; or
wherein the first precursor is formed by suspending the first electrode active material and the charging agent, and optionally, the conducting agent in the liquid electrolyte and/or the second precursor is formed by suspending the second electrode active material and the charging agent, and optionally, the conducting agent in the liquid electrolyte.

55. The method according to claim 40, wherein step (ii) is performed in an electrochemical cell comprising:
a first EPD electrode and a second EPD electrode, which are in ionic contact with the membrane; and
a first compartment and a second compartment, which are separated by the membrane,
wherein the first precursor is disposed in the first compartment and the second precursor is disposed in the second compartment.

56. The method according to claim 55, wherein the first compartment is disposed within the second compartment; or
wherein the first compartment and the second compartment are linearly aligned; or
wherein the first EPD electrode is disposed within the first compartment and the second electrode is disposed within the second compartment.

57. The method according to claim 40, wherein the EPD process in step (ii) is performed at a constant voltage ranging from about 20 to about 600 V; or
wherein the EPD process in step (ii) is performed for from about 5 seconds to about 30 minutes; or
wherein the first EPD electrode, the second EPD electrode or both are disposed within less than about 30 cm from the membrane.

58. A membrane-electrode assembly (MEA) prepared by the method according to claim 40, wherein the first MEA electrode comprises the first electrode active material and the second MEA electrode comprises the second electrode active material.

59. The MEA according to claim 58, wherein the first MEA electrode, the second MEA electrode or both further comprise at least one of the charging agent, the conducting agent, and the binder; or wherein the first MEA electrode is essentially free of the second electrode active material and/or the second MEA electrode is essentially free of the first electrode active material.

60. An energy storage device comprising the MEA according to claim 58, selected from the group consisting of a Li-ion battery, fuel cell, flow cell, supercapacitor, and photoelectrochemical cell.
